(19) United States
(12) Patent Application Publication
(10) Pub. No.: US 2024/0340982 A1
(43) Pub. Date: Oct. 10, 2024

(54) UNLOCKING METHOD, ELECTRONIC DEVICE, AND SYSTEM

(71) Applicant: HUAWEI TECHNOLOGIES CO., LTD., Shenzhen (CN)

(72) Inventor: Tianliang Xu, Xi’an (CN)

(73) Assignee: HUAWEI TECHNOLOGIES CO., LTD., Shenzhen (CN)

(21) Appl. No.: 18/749,524

(22) Filed: Jun. 20, 2024

Related U.S. Application Data
(63) Continuation of application No. PCT/CN2022/137623, filed on Dec. 8, 2022.

(30) Foreign Application Priority Data
Jan. 17, 2022 (CN) 202210051773.7

(51) Int. Cl. H04W 76/10; E05B 81/64; G07C 9/00; H04W 4/90; H04W 12/06

(52) U.S. Cl. CPC H04W 76/10; E05B 81/64; G07C 9/00309; H04W 12/06; H04W 4/90

(57) ABSTRACT

This application provides an unlocking method, an electronic device, and a system, and relates to the field of terminal technologies.-The method includes: After a first electronic device determines, based on first data, that there is a first risk in an environment in which the first electronic device is located, the first electronic device establishes a connection to a second electronic device in response to a connection request sent by the second electronic device. Then, when the first electronic device determines that there is the first risk in the environment in which the first electronic device is located and a login account of the second electronic device is authorized, the first electronic device confirms to perform unlocking.

### CROSS-REFERENCE TO RELATED APPLICATIONS

This application is a continuation of International Application No. PCT/CN2022/137623, filed on Dec. 8, 2022, which claims priority to Chinese Patent Application No. 202210051773.7, filed on Jan. 17, 2022. The disclosures of the aforementioned applications are hereby incorporated by reference in their entireties.

### TECHNICAL FIELD

Embodiments of this application relate to the field of terminal technologies, and in particular, to an unlocking method, an electronic device, and a system.

### BACKGROUND

With development of terminal technologies, more consumers use intelligent electronic devices (for example, a smart room door lock and a smart car door lock). The electronic device can provide a fingerprint recognition function or a password function, so that a user can quickly unlock a door by using a fingerprint or a password without carrying a key.

However, the intelligent device may be unreliable in some emergencies. For example, a fire in a home may damage a smart apparatus in a smart room door lock, and consequently the user cannot perform unlocking. For another example, a child is locked in a vehicle, causing a danger.

### SUMMARY

To resolve the foregoing technical problem, embodiments of this application provide an unlocking method, an electronic device, and a system. According to the technical solution provided in embodiments of this application, when a first electronic device determines that there is a risk in an environment in which the first electronic device is located, the first electronic device allows establishing a connection to a second electronic device. After the first electronic device determines that a login account of the second electronic device is authorized, the first electronic device may confirm to perform unlocking, to avoid a danger.

To achieve the foregoing technical objective, embodiments of this application provide the following technical solutions:

According to a first aspect, an unlocking method is provided. The method is applied to a first electronic device. The method includes: obtaining first data; determining, based on the first data, that there is a first risk in an environment in which the first electronic device is located; establishing a connection to a second electronic device in response to a connection request sent by the second electronic device; determining that a login account of the second electronic device is authorized; and when there is the first risk in the environment in which the first electronic device is located, and it is determined that the login account of the second electronic device is authorized, confirming to perform unlocking.

In some embodiments, the environment in which the first electronic device is located includes an environment in which the first electronic device is closed. The login account of the second electronic device includes an account logged in an application installed in the second electronic device.

In some embodiments, the first data includes one or more of environment monitoring data, user monitoring data, user data, and security level data.

The environment monitoring data includes, for example, temperature data, smoke concentration data, and camera monitoring data of the environment in which the first electronic device is closed. The user monitoring data includes, for example, a heart rate, blood pressure, and blood oxygen detected by a wearable device. The user data includes, for example, disease data, an age, and a gender of the user. The security level data is a security level determined based on at least one of the environment monitoring data, the user monitoring data, the user data, and the like, for example, a normal mode, a dangerous mode, or an emergency mode.

In this way, when there is a risk in the environment in which the first electronic device is closed, a stranger may also complete unlocking on the first electronic device after completing authorization on the account login by using the second electronic device carried by the stranger. This avoids a danger or a property loss caused when the risk occurs and an owner of the first electronic device (for example, a user who knows a password of the first electronic device, or a user whose fingerprint template is stored in the first electronic device) does not appear nearby.

In addition, the second electronic device whose login account is authorized is allowed to indicate the first electronic device to perform unlocking, so as to avoid, to some extent, a hazard that is caused to an article in the environment in which the first electronic device is closed, and that is caused when any second electronic device indicates the first electronic device to perform unlocking.

According to any one of the first aspect or the implementations of the first aspect, the obtaining first data includes: obtaining the first data sent by one or more of a sensor in the environment in which the first electronic device is located, a sensor of the first electronic device, a third electronic device that is provided with a sensor and that is in the environment in which the first electronic device is located, and a central control device in the environment in which the first electronic device is located.

In some embodiments, the first electronic device can establish a communication connection to one or more sensors that can monitor an environment and that are included in the environment in which the first electronic device is located or to a device in which the sensors are located, to obtain environment monitoring data monitored by each sensor. The central control device includes, for example, a smart home control panel (which may alternatively be another central control device in a room) and a vehicle central control device.

In this way, the first electronic device can combine first data obtained through a plurality of channels to determine more accurately whether there is the first risk in the environment in which the first electronic device is located. This avoids a loss that is in the environment in which the first electronic device is located and that is caused by connecting the second electronic device of the stranger to the first electronic device due to a misjudgment.

According to any one of the first aspect or the implementations of the first aspect, the determining that a login account of the second electronic device is authorized includes: obtaining a first signal sent by the second electronic device, where the first signal carries authorization confirmation information, and the authorization confirmation information is information sent by a first server to the second electronic device after the first server determines that the login account of the second electronic device is authorized; and determining, based on the first signal, that the login account of the second electronic device is authorized; or obtaining a second signal that is sent by the first server and forwarded by a second server; and determining, based on the second signal, that the login account of the second electronic device is authorized.

In some embodiments, the first electronic device may determine an authorization status of the login account of the second electronic device in a plurality of implementations. For example, in an implementation (1), after determining an unlocking authorization status of the second electronic device, the first server may send a fourth signal indicating the authorization status to the second electronic device, and then send the first signal to the first electronic device. The first electronic device may determine the authorization status of the login account of the second electronic device based on the obtained first signal sent by the second electronic device. For another example, in an implementation (2), after determining unlocking authorization status of the second electronic device, the first server may send, to the second server for managing the first electronic device, the second signal that carries the unlocking authorization status, and the second server forwards the second signal to the first electronic device. Then, the first electronic device determines the unlocking authorization status of the second electronic device based on the second signal. For another example, in an implementation (3), with reference to the implementation (1) and the implementation (2), the first electronic device determines the authorization status of the login account of the second electronic device based on the first signal and the second signal.

In this way, the first electronic device can determine the authorization status of the login account of the second electronic device in a plurality of manners, and further determine whether the second electronic device is allowed to indicate the first electronic device to perform unlocking.

According to any one of the first aspect or the implementations of the first aspect, the determining that a login account of the second electronic device is authorized includes: Real-name identity information of a user is bound to the login account of the second electronic device.

In some embodiments, generally, a user identity is authenticated during creation of an account like a Huawei account or an account of a specific application (for example, WeChat® or Alipay®). After identity authentication succeeds, account creation is completed. For example, real-name authentication is performed on the user based on identity document information, face information, and a real name of the user to complete account creation.

A real-name authentication account has higher security, and the user identity authenticated by using the real-name authentication account can better ensure security in the environment in which the first electronic device is closed.

According to any one of the first aspect or the implementations of the first aspect, before the confirming to perform unlocking, the method further includes: receiving a third signal sent by the second electronic device, where the third signal indicates the first electronic device to perform unlocking.

In some embodiments, after the second electronic device determines that authorization on the login account succeeds, the second electronic device may display an unlocking confirmation interface. Then, the second electronic device determines, based on a second operation performed by the user on the interface, whether to indicate the first electronic device to perform unlocking. If the second electronic device determines to indicate the first electronic device to perform unlocking, the second electronic device may send, to the first electronic device, a third signal indicating to perform unlocking. Correspondingly, the first electronic device may receive the third signal, and confirm, based on the third signal, to perform unlocking.

In this way, the third signal indicating to perform unlocking enhances flexibility of indicating by the user to perform unlocking, and avoids a risk caused through direct unlocking. For example, if a danger like a fire occurs in a room in which a smart door lock is closed and a user who performs unlocking is not well-prepared, direct unlocking may cause a specific loss.

According to any one of the first aspect or the implementations of the first aspect, before the confirming to perform unlocking, the method further includes: obtaining a face image of a user who indicates, by using the second electronic device, to perform unlocking.

In some embodiments, during authorization on the login account, the second electronic device may further collect the face image of the user, so that the owner of the first electronic device subsequently confirms an identity of a user who performs unlocking. This increases traceability, and further ensures security of an article in the environment in which the first electronic device is closed.

According to any one of the first aspect or the implementations of the first aspect, the method further includes: sending the face image to a second server, where the second server is a server for managing the first electronic device.

For example, if the second electronic device has a smart home service function (for example, a smart home application is installed), and the user has registered an account of the smart home application, the second electronic device can establish a connection to a smart home server (the second server), and can send the obtained face image of the user to the smart home server. The smart home server is also a server corresponding to the first electronic device, namely, a server for managing the first electronic device. Subsequently, the first electronic device or another electronic device of the owner of the first electronic device may request the smart home server to download the face image of the user, or the smart home server may directly send the face image of the user to the first electronic device or another electronic device of the owner of the first electronic device. Therefore, the owner of the first electronic device can determine, based on the obtained face image of the user, a user who indicates to perform unlocking.

For another example, after obtaining the face image of the user, the second electronic device may directly send the face image of the user to the first electronic device (for example, when the second electronic device does not have a smart home service function). Optionally, after obtaining the face image of the user, the first electronic device may further upload the face image of the user to the second server for backup. Similarly, the owner of the first electronic device can determine, based on the obtained face image of the user, a user who indicates to perform unlocking.

According to any one of the first aspect or the implementations of the first aspect, the first risk includes one or more of the following: a fire risk, a flood risk, an individual activity risk of a child, and a risk of disease in the elderly.

In this way, the first electronic device can identify, based on the obtained first data, a plurality of risk scenarios that may cause a danger. Further, after determining the first risk, the first electronic device can allow access of the second electronic device of the stranger; and after confirming unlocking authorization on the login account, the first electronic device may allow indicating to perform unlocking. This effectively reduces possible hazard caused by a plurality of risks.

According to any one of the first aspect or the implementations of the first aspect, after the determining, based on the first data, that there is a first risk in an environment in which the first electronic device is located, the method further includes: playing an alarm audio by using an audio module, and/or flashing an indicator light.

In this way, after the first electronic device determines that there is the first risk in the environment in which the first electronic device is located, the first electronic device can attract attention of a surrounding person by using the audio module and/or the indicator light, to avoid a risk that has a bigger danger and that occurs because no one notices a danger in a current environment in which a smart door lock is closed.

According to any one of the first aspect or the implementations of the first aspect, the method further includes: obtaining second data, where the second data includes the first data; determining, based on the second data, whether there is the first risk in the environment in which the first electronic device is located; and after it is determined that there is no first risk in the environment in which the first electronic device is located, confirming to perform locking.

In this way, the first electronic device can adaptively determine, based on the environment monitoring data, whether to allow performing unlocking as indicated by an owner of an electronic device other than the first electronic device. This can flexibly reduce a risk and ensure property security of an owner of the smart door lock.

According to a second aspect, an unlocking method is provided. The method is applied to a second electronic device. The method includes: sending a connection request to a first electronic device, and establishing a connection to the first electronic device; displaying a first interface; obtaining login account information in response to a first operation performed on the first interface; obtaining, based on the login account information, unlocking authorization that allows controlling the first electronic device to perform unlocking; and sending a first signal to the first electronic device, where the first signal indicates that a login account of the second electronic device is authorized.

According to the second aspect, the obtaining, based on the login account information, unlocking authorization that allows controlling the first electronic device to perform unlocking includes: sending the login account information to the first server; receiving a fourth signal sent by the first server, where the fourth signal is a signal sent by the first server after the first server determines unlocking authorization based on the login account information; and obtaining, based on the fourth signal, unlocking authorization that allows controlling the first electronic device to perform unlocking.

According to any one of the second aspect or the implementations of the second aspect, before the sending a first signal to the first electronic device, the method further includes: collecting a face image of a user; and sending the face image of the user to a second server and/or the first electronic device, where the second server is a server for managing the first electronic device.

According to any one of the second aspect or the implementations of the second aspect, the method further includes: sending a third signal to the first electronic device, where the third signal indicates the first electronic device to perform unlocking.

According to any one of the second aspect or the implementations of the second aspect, the sending a third signal to the first electronic device includes: displaying a second interface, and sending the third signal to the first electronic device in response to a second operation performed on the second interface.

For technical effects corresponding to any one of the second aspect or the implementations of the second aspect, refer to technical effects corresponding to any one of the first aspect or the implementations of the first aspect. Details are not described herein again.

According to a third aspect, an unlocking method is provided. The method includes: A first electronic device determines that there is a first risk in an environment in which the first electronic device is located. When there is the first risk in the environment in which the first electronic device is located, the first electronic device allows a second electronic device to establish a connection to the first electronic device. The second electronic device is an electronic device to which the first electronic device is not allowed to establish a connection when there is no first risk in the environment in which the first electronic device is located. After the first electronic device establishes a connection to the second electronic device, the second electronic device sends login account information of the second electronic device to a first server. The first server is a server for managing a login account corresponding to the login account information. The second electronic device receives a fourth signal sent by the first server. The fourth signal is a signal sent by the first server after the first server determines unlocking authorization based on the login account information. The second electronic device obtains, based on the fourth signal, unlocking authorization that allows controlling the first electronic device to perform unlocking. The second electronic device sends a first signal to the first electronic device. The first signal indicates that the login account of the second electronic device is authorized. The first electronic device confirms, based on the first signal, to perform unlocking.

According to the third aspect, before the second electronic device sends the first signal to the first electronic device, the method further includes: The second electronic device obtains a face image of a user who indicates, by using the second electronic device, to perform unlocking. The second electronic device sends the face image of the user to a second server and/or the first electronic device. The second server is a server for managing the first electronic device.

According to any one of the third aspect or the implementations of the third aspect, that the first electronic device determines that there is the first risk in the environment in which the first electronic device is located includes: The first electronic device determines, based on first data, that there is the first risk in the environment in which the first electronic device is located. The first data includes one or more of environment monitoring data, user monitoring data, user data, and security level data.

According to any one of the third aspect or the implementations of the third aspect, the method further includes: The first electronic device obtains second data. The second data includes the first data. The first electronic device determines, based on the second data, whether there is the first risk in the environment in which the first electronic device is located. After the first electronic device determines that there is no first risk in the environment in which the first electronic device is located, the first electronic device confirms to perform locking.

For technical effects corresponding to any one of the third aspect or the implementations of the third aspect, refer to technical effects corresponding to any one of the first aspect or the implementations of the first aspect. Details are not described herein again.

According to a fourth aspect, an electronic device is provided. The electronic device is a first electronic device. The first electronic device includes a processor and a memory. The memory is coupled to the processor. The memory is configured to store computer-readable instructions. The processor reads the computer-readable instructions from the memory, to enable the first electronic device to perform the following steps: obtaining first data; determining, based on the first data, that there is a first risk in an environment in which the first electronic device is located; establishing a connection to a second electronic device in response to a connection request sent by the second electronic device; determining that a login account of the second electronic device is authorized; and when there is the first risk in the environment in which the first electronic device is located, and it is determined that the login account of the second electronic device is authorized, confirming to perform unlocking.

According to the fourth aspect, the first data includes one or more of environment monitoring data, user monitoring data, user data, and security level data.

According to any one of the fourth aspect or the implementations of the fourth aspect, the obtaining first data includes: obtaining the first data sent by one or more of a sensor in the environment in which the first electronic device is located, a sensor of the first electronic device, a third electronic device that is provided with a sensor and that is in the environment in which the first electronic device is located, and a central control device in the environment in which the first electronic device is located.

According to any one of the fourth aspect or the implementations of the fourth aspect, the determining that a login account of the second electronic device is authorized includes: obtaining a first signal sent by the second electronic device, where the first signal carries authorization confirmation information, and the authorization confirmation information is information sent by a first server to the second electronic device after the first server determines that the login account of the second electronic device is authorized; and determining, based on the first signal, that the login account of the second electronic device is authorized; or obtaining a second signal that is sent by the first server and forwarded by a second server; and determining, based on the second signal, that the login account of the second electronic device is authorized.

According to any one of the fourth aspect or the implementations of the fourth aspect, the determining that a login account of the second electronic device is authorized includes: Real-name identity information of a user is bound to the login account of the second electronic device.

According to any one of the fourth aspect or the implementations of the fourth aspect, when the processor reads the computer instructions from the memory, the first electronic device is further enabled to perform the following operation: receiving a third signal sent by the second electronic device, where the third signal indicates the first electronic device to perform unlocking.

According to any one of the fourth aspect or the implementations of the fourth aspect, when the processor reads the computer instructions from the memory, the first electronic device is further enabled to perform the following operation: obtaining a face image of a user who indicates, by using the second electronic device, to perform unlocking.

According to any one of the fourth aspect or the implementations of the fourth aspect, when the processor reads the computer instructions from the memory, the first electronic device is further enabled to perform the following operation: sending the face image to the second server, where the second server is a server for managing the first electronic device.

According to any one of the fourth aspect or the implementations of the fourth aspect, the first risk includes one or more of the following: a fire risk, a flood risk, an individual activity risk of a child, and a risk of disease in the elderly.

According to any one of the fourth aspect or the implementations of the fourth aspect, when the processor reads the computer instructions from the memory, the first electronic device is further enabled to perform the following operations: playing, by an audio module, an alarm audio, and/or flashing an indicator light.

According to any one of the fourth aspect or the implementations of the fourth aspect, when the processor reads the computer instructions from the memory, the first electronic device is further enabled to perform the following operations: obtaining second data, where the second data includes the first data; determining, based on the second data, whether there is the first risk in the environment in which the first electronic device is located; and after it is determined that there is no first risk in the environment in which the first electronic device is located, confirming to perform locking.

For technical effects corresponding to any one of the fourth aspect or the implementations of the fourth aspect, refer to technical effects corresponding to any one of the first aspect or the implementations of the first aspect. Details are not described herein again.

According to a fifth aspect, an electronic device is provided. The electronic device is a second electronic device. The second electronic device includes a processor, a memory, and a display. The memory and the display are coupled to the processor. The memory is configured to store computer-readable instructions. When the processor reads the computer-readable instructions from the memory, the second electronic device is enabled to perform the following steps: sending a connection request to a first electronic device, and establishing a connection to the first electronic device; displaying a first interface; obtaining login account information in response to a first operation performed on the first interface; obtaining, based on the login account information, unlocking authorization that allows controlling the first electronic device to perform unlocking; and sending a first signal to the first electronic device, where the first signal indicates that a login account of the second electronic device is authorized.

According to the fifth aspect, the obtaining, based on the login account information, unlocking authorization that allows controlling the first electronic device to perform unlocking includes: sending the login account information to the first server; receiving a fourth signal sent by the first server, where the fourth signal is a signal sent by the first server after the first server determines unlocking authorization based on the login account information; and obtaining, based on the fourth signal, unlocking authorization that allows controlling the first electronic device to perform unlocking.

According to any one of the fifth aspect or the implementations of the fifth aspect, when the processor reads the computer instructions from the memory, the second electronic device is further enabled to perform the following operations: collecting a face image of the user; and sending the face image of the user to a second server and/or the first electronic device, where the second server is a server for managing the first electronic device.

According to any one of the fifth aspect or the implementations of the fifth aspect, when the processor reads the computer instructions from the memory, the second electronic device is further enabled to perform the following operation: sending a third signal to the first electronic device, where the third signal indicates the first electronic device to perform unlocking.

According to any one of the fifth aspect or the implementations of the fifth aspect, the sending a third signal to the first electronic device includes: displaying a second interface, and sending the third signal to the first electronic device in response to a second operation performed on the second interface. For technical effects corresponding to any one of the fifth aspect or the implementations of the fifth aspect, refer to technical effects corresponding to any one of the first aspect or the implementations of the first aspect. Details are not described herein again.

For technical effects corresponding to any one of the fifth aspect or the implementations of the fifth aspect, refer to technical effects corresponding to any one of the second aspect or the implementations of the second aspect. Details are not described herein again.

According to a sixth aspect, an embodiment of this application provides an unlocking system. The unlocking system includes a first electronic device, a second electronic device, and a first server. The first electronic device is configured to perform the method according to any one of the first aspect or the implementations of the first aspect, the second electronic device is configured to perform the method according to any one of the second aspect or the implementations of the second aspect, and the first server is configured to perform authorization confirmation on a login account of the second electronic device.

For technical effects corresponding to any one of the sixth aspect or the implementations of the sixth aspect, refer to technical effects corresponding to any one of the first aspect or the implementations of the first aspect. Details are not described herein again.

According to a seventh aspect, an embodiment of this application provides an electronic device. The electronic device has a function of implementing the unlocking method according to any one of the first aspect and the possible implementations of the first aspect. The function may be implemented by hardware, or may be implemented by hardware executing corresponding software. The hardware or the software includes one or more modules corresponding to the function.

For technical effects corresponding to any one of the seventh aspect or the implementations of the seventh aspect, refer to technical effects corresponding to any one of the first aspect or the implementations of the first aspect. Details are not described herein again.

According to an eighth aspect, an embodiment of this application provides an electronic device. The electronic device has a function of implementing the unlocking method according to any one of the second aspect and the possible implementations of the second aspect. The function may be implemented by hardware, or may be implemented by hardware executing corresponding software. The hardware or the software includes one or more modules corresponding to the function.

For technical effects corresponding to any one of the eighth aspect or the implementations of the eighth aspect, refer to technical effects corresponding to any one of the second aspect or the implementations of the second aspect. Details are not described herein again.

According to a ninth aspect, a computer-readable storage medium is provided. The computer-readable storage medium stores a computer program (which may also be referred to as an instruction or code). When the computer program is executed by an electronic device, the electronic device is enabled to perform the method according to any one of the first aspect or the implementations of the first aspect, or the electronic device is enabled to perform the method according to any one of the second aspect or the implementations of the second aspect.

For technical effects corresponding to any one of the ninth aspect or the implementations of the ninth aspect, refer to technical effects corresponding to any one of the first aspect or the implementations of the first aspect. Details are not described herein again.

According to a tenth aspect, an embodiment of this application provides a computer program product. When the computer program product runs on an electronic device, the electronic device is enabled to perform the method according to any one of the first aspect or the implementations of the first aspect. Alternatively, when the computer program product runs on an electronic device, the electronic device is enabled to perform the method according to any one of the second aspect or the implementations of the second aspect.

For technical effects corresponding to any one of the tenth aspect or the implementations of the tenth aspect, refer to technical effects corresponding to any one of the first aspect or the implementations of the first aspect. Details are not described herein again.

According to an eleventh aspect, an embodiment of this application provides a circuit system. The circuit system includes a processing circuit. The processing circuit is configured to perform the method according to any one of the first aspect or the implementations of the first aspect. Alternatively, the processing circuit is configured to perform the method according to any one of the second aspect or the implementations of the second aspect.

For technical effects corresponding to any one of the eleventh aspect or the implementations of the eleventh aspect, refer to technical effects corresponding to any one of the first aspect or the implementations of the first aspect. Details are not described herein again.

According to a twelfth aspect, an embodiment of this application provides a chip system, including at least one processor and at least one interface circuit. The at least one interface circuit is configured to: perform a transceiver function, and send instructions to the at least one processor. When the at least one processor executes the instructions, the at least one processor performs the method according to any one of the first aspect or the implementations of the first aspect. Alternatively, when the at least one processor executes the instructions, the at least one processor performs the method according to any one of the second aspect or the implementations of the second aspect.

For technical effects corresponding to any one of the twelfth aspect or the implementations of the twelfth aspect, refer to technical effects corresponding to any one of the first aspect or the implementations of the first aspect. Details are not described herein again.

### BRIEF DESCRIPTION OF DRAWINGS

FIG. 1 is a schematic diagram of a communication system to which an unlocking method is applied according to an embodiment of this application;

FIG. 2 is a schematic diagram of a hardware structure of a first electronic device according to an embodiment of this application;

FIG. 3 is a schematic diagram of a hardware structure of a second electronic device according to an embodiment of this application;

FIG. 4 is a schematic flowchart of a security level determining method according to an embodiment of this application;

FIG. 5 is a schematic diagram of a security level and a corresponding processing manner according to an embodiment of this application;

FIG. 6(a) to FIG. 6(d) each are a schematic diagram 1 of an interface according to an embodiment of this application;

FIG. 7 is a schematic diagram 2 of an interface according to an embodiment of this application;

FIG. 8 is a schematic diagram 3 of an interface according to an embodiment of this application;

FIG. 9 is a schematic diagram 4 of an interface according to an embodiment of this application;

FIG. 10 is a schematic diagram 5 of an interface according to an embodiment of this application;

FIG. 11A-1 and FIG. 11A-2 are a schematic flowchart 1 of an unlocking method according to an embodiment of this application;

FIG. 11B-1 and FIG. 11B-2 are a schematic flowchart 2 of an unlocking method according to an embodiment of this application;

FIG. 12A and FIG. 12B are a schematic flowchart 3 of an unlocking method according to an embodiment of this application;

FIG. 13A and FIG. 13B are a schematic flowchart 4 of an unlocking method according to an embodiment of this application;

FIG. 14 is a schematic diagram of a structure of a first electronic device according to an embodiment of this application; and

FIG. 15 is a schematic diagram of a structure of a second electronic device according to an embodiment of this application.

### DESCRIPTION OF EMBODIMENTS

The following describes the technical solutions in embodiments of this application with reference to the accompanying drawings in embodiments of this application. In the descriptions of embodiments of this application, the terms used in the following embodiments are merely intended to describe purposes of specific embodiments, but are not intended to limit this application. The terms “one”, “a”, “the”, “the foregoing”, “this”, and “the one” of singular forms used in this specification and the appended claims of this application are intended to include expressions such as “one or more”, unless otherwise specified in the context clearly. It should be further understood that, in the following embodiments of this application, “at least one” and “one or more” mean one, two, or more.

Reference to “an embodiment”, “some embodiments”, or the like described in this specification indicates that one or more embodiments of this application include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean reference to a same embodiment, instead, they mean “one or more but not all of embodiments”, unless otherwise specifically emphasized. The terms “include”, “comprise”, “have”, and their variants all mean “include but are not limited to”, unless otherwise specifically emphasized. The term “connection” includes a direct connection and an indirect connection, unless otherwise indicated. “First” and “second” are merely intended for a purpose of description, and shall not be understood as an indication or implication of relative importance or implicit indication of the quantity of indicated technical features.

In embodiments of this application, the terms “example”, “for example”, or the like is used to represent giving an example, an illustration, or a description. Any embodiment or design scheme described as “example” or “for example” in embodiments of this application should not be explained as being more preferred or having more advantages than another embodiment or design scheme. Exactly, use of the term “example”, “for example”, or the like is intended to present a relative concept in a specific manner.

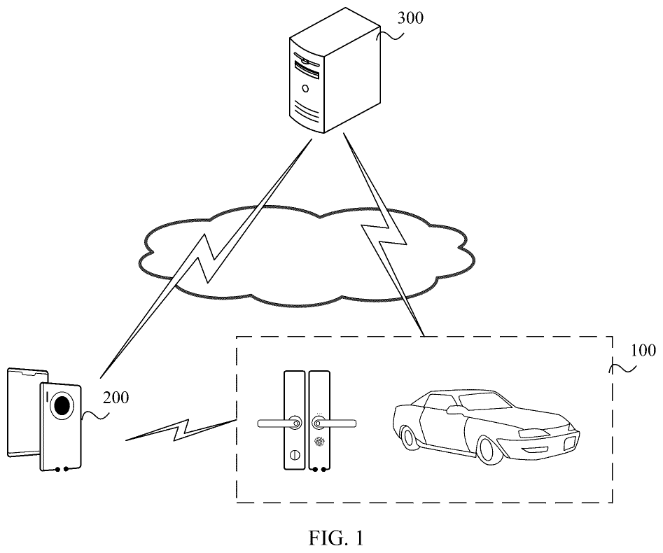

FIG. 1 is a schematic diagram of a communication system to which an unlocking method is applied according to an embodiment of this application. As shown in FIG. 1, the communication system includes a first electronic device 100, a second electronic device 200, and a server 300. The first electronic device 100 and the second electronic device 200 separately establish a communication connection to the server 300 in a wireless connection manner. A connection manner between the first electronic device 100 or the second electronic device 200 and the server 300 is not specifically limited in embodiments of this application.

Optionally, the first electronic device 100 may establish a wireless communication connection to the second electronic device 200 by using a wireless communication technology. The wireless communication technology includes but is not limited to at least one of the following: Bluetooth (Bluetooth, BT) (for example, conventional Bluetooth or Bluetooth low energy (Bluetooth low energy, BLE) Bluetooth), a wireless local area network (wireless local area network, WLAN) (for example, a wireless fidelity (wireless fidelity, Wi-Fi) network), near field communication (near field communication, NFC), Zigbee (Zigbee), frequency modulation (frequency modulation, FM), and infrared (infrared, IR).

In some embodiments, both the first electronic device 100 and the second electronic device 200 support a proximity detection function. For example, after the second electronic device 200 approaches the first electronic device 100, the second electronic device 200 and the first electronic device 100 can discover each other, and then establish a wireless communication connection like a Bluetooth connection or a Wi-Fi peer to peer (peer to peer, P2P) connection. Then, a user may control, by using the second electronic device 200, the first electronic device 100 to open a door lock.

In some embodiments, the first electronic device 100 and the second electronic device 200 establish a wireless communication connection through a local area network. For example, both the first electronic device 100 and the second electronic device 200 are connected to a same router.

In some embodiments, the first electronic device 100 and the second electronic device 200 establish a wireless communication connection through a cellular network, the Internet, or the like. For example, the second electronic device 200 accesses the Internet by using a router, and the first electronic device 100 accesses the Internet through the cellular network, so that the first electronic device 100 and the second electronic device 200 separately establish a wireless communication connection.

In some embodiments, the second electronic device 200 is provided with a wireless transceiver, and the second electronic device 200 establishes a wireless communication connection to the first electronic device 100 by using the wireless transceiver.

Optionally, the first electronic device 100 includes but is not limited to an electronic device with an unlocking function, for example, a smart home device (for example, a smart door lock (for example, a smart room door lock) or a smart camera), a smart car door lock, a vehicle provided with a smart car door lock, a mobile phone, and a laptop (Laptop). An operating system may be installed in the first electronic device 100. The operating system installed in the first electronic device 100 includes but is not limited to iOS®, Android®, Harmony®, Windows®, Linux®, or another operating system. Alternatively, an operating system may not be installed in the first electronic device 100. A specific type of the first electronic device 100, whether an operating system is installed, or a type of an installed operating system is not limited in this application.

It should be noted that unlocking the first electronic device 100 may be unlocking a door by retracting a bolt (for example, the first electronic device 100 is a smart door lock), or clearing a screen-locked state and starting a system (for example, the first electronic device 100 is a mobile phone). This is not specifically limited in embodiments of this application.

Optionally, the second electronic device 200 may be a terminal device, for example, a mobile phone (mobile phone), a tablet computer (Pad), a personal computer (personal computer, PC), a notebook computer, a computer with a transceiver function, a wearable device, or an artificial intelligence (artificial intelligence, AI) device. An operating system installed in the second electronic device 200 includes but is not limited to iOS®, Android®, Harmony®, Windows®, Linux®, or another operating system. In some embodiments, the second electronic device 200 may be a fixed device or a portable device. A specific type of the second electronic device 200 and the operating system installed in the second electronic device 200 are not limited in this application.

Optionally, the server 300 may be a device or a network device that has a computing function, for example a cloud server or a network server. The server 300 may be one server, a server cluster including a plurality of servers, or a cloud computing service center. For example, in FIG. 1, the server 300 may perform an unlocking method provided in embodiments of this application.

In some embodiments, the server 300 may include a first server and a second server. The first server is configured to manage a login account of the second electronic device 200, and can perform authorization and authentication on the login account of the second electronic device 200, to determine whether the user is allowed to control the first electronic device 100 by using the second electronic device 200. For example, after authorization and authentication on the login account succeed, the second electronic device 200 can control the first electronic device 100 to perform unlocking. Optionally, the first server includes, for example, a Huawei server that can perform authorization and authentication on a Huawei account, a WeChat® server that can perform authorization and authentication on a WeChat® account and an Alipay® server that can perform authorization and authentication on an Alipay® account. For example, the second server includes a server for managing the first electronic device 100. For example, the first electronic device 100 is a smart home door lock, and the second server may be a smart home server. Optionally, the server 300 may alternatively be a server or a server cluster that can implement a function of the first server and a function of the second server.

In some embodiments, the first electronic device 100 is a smart door lock, and a fingerprint recognition function or a password function may be configured in the smart door lock, so that the user can open the smart door lock without carrying a key. This facilitates an operation of the user. However, the smart door lock may also be unreliable, affecting user experience.

For example, the smart door lock is a smart room door lock. Generally, one or more fingerprint templates used for unlocking are stored in the smart room door lock in advance, and unlocking is performed only after it is determined that an input fingerprint matches the fingerprint template. However, in an emergency scenario like an indoor fire and water immersion, if a householder is not at home, unlocking cannot be performed timely, and another stranger does not have unlocking permission, which may cause a danger. In addition, if the fire is not stopped timely at the beginning, there is a risk of high temperature damage to the smart room door lock. After the smart room door lock is damaged, the householder may no longer indicate the smart door lock to perform unlocking, which endangers safety of people getting stuck inside.

For another example, the smart door lock is a smart car door lock. A child may be stranded in a vehicle due to parental negligence. If all windows and doors are not opened, after interior space is closed for a long time, oxygen content is reduced. In this case, the child in the vehicle cannot escape independently, which may cause a danger of suffocation, even a danger of death from a high temperature at summer. Further, if another person outside the vehicle finds the current risk in the vehicle, because the smart car door lock cannot be directly opened, the person can rescue the trapped person only by breaking a window, resulting in a property loss of a vehicle owner.

In view of this, an embodiment of this application provides an unlocking method. When a first electronic device (for example, a smart door lock) can monitor an environment, for example, determine a current environment as a preset dangerous scenario, the first electronic device can perform automatic unlocking. Alternatively, after a first electronic device determines that a login account of a second electronic device (for example, a mobile phone) is authorized, the first electronic device allows the second electronic device to open a door lock. This reduces an accident risk and improves user experience.

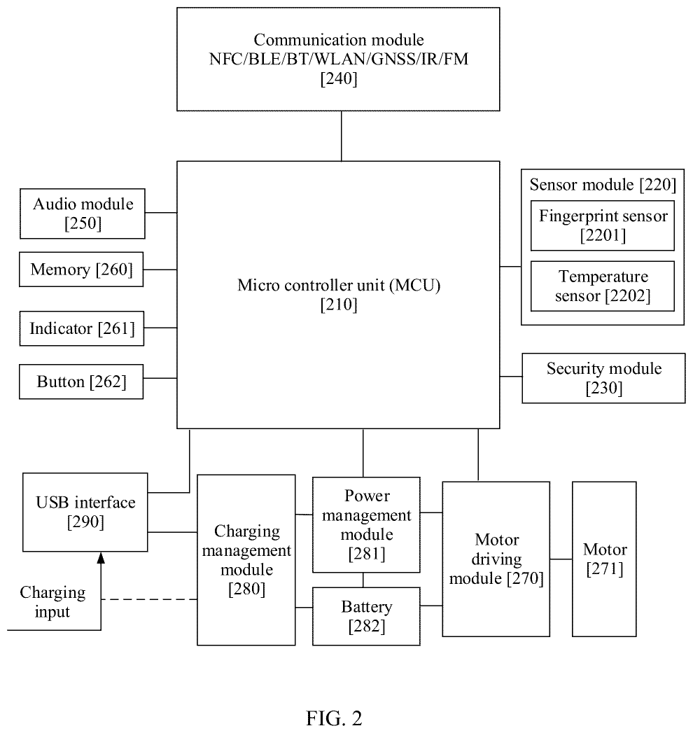

For example, FIG. 2 is a schematic diagram of a structure of the electronic device 100. As shown in FIG. 2, the first electronic device 100 may include, for example, a micro controller unit (micro controller unit, MCU) 210, a sensor module 220, a security module 230, a communication module 240, an audio module 250, a memory 260, an indicator 261, a button 262, a motor driving module 270, a motor 271, a charging management module 280, a power management module 281, a battery 282, a universal serial bus (universal serial bus, USB) interface 290, and the like.

It may be understood that a structure shown in this embodiment of this application does not constitute a specific limitation on the first electronic device 100. In some other embodiments of this application, the first electronic device 100 may include more or fewer components than those shown in the figure, or combine some components, or split some components, or have different component arrangements. The components shown in the figure may be implemented by hardware, software, or a combination of software and hardware.

The MCU 210 may include one or more processing units. For example, the MCU 210 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural-network processing unit (neural-network processing unit, NPU), and/or the like. Different processing units may be independent components, or may be integrated into one or more processors.

The controller may generate an operation control signal based on instruction operation code and a time sequence signal, to complete control of instruction reading and instruction execution.

A memory may be further disposed in the MCU 210, and is configured to store instructions and data. In some embodiments, the memory in the MCU 210 is a cache. The memory may store instructions or data just used or cyclically used by the MCU 210. If the MCU 210 needs to use the instructions or the data again, the MCU may directly invoke the instructions or the data from the memory. This avoids repeated access and reduces waiting time of the MCU 210, so that system efficiency is improved.

The sensor module 220 may include a fingerprint sensor 2201 and a temperature sensor 2202. The fingerprint sensor 2201 is configured to collect a fingerprint input by a user, to implement a fingerprint unlock function of the first electronic device 100. The temperature sensor 2202 is configured to monitor an ambient temperature.

The security module 230 is configured to determine a security level of the first electronic device 100. Optionally, the security level includes, for example, one or more of a normal mode, a dangerous mode, and an emergency mode.

In some embodiments, the security module 230 can obtain data such as data monitored by the sensor module 220 and environment monitoring data sent by another electronic device, and determine a current security level based on the obtained data.

For example, the first electronic device 100 is a smart door lock. The security module 230 in the first electronic device 100 can obtain environment monitoring data detected by a sensor of the first electronic device 100, or environment monitoring data sent by a sensor (for example, a temperature sensor or a smoke sensor) configured at home or a device provided with a sensor. The environment monitoring data includes, for example, a temperature and smoke concentration. For example, the security module 230 determines, based on the environment monitoring data, that a current temperature in a room exceeds a threshold 1. In this case, the security module 230 determines that there is currently a fire risk in the room, and may determine the security level as the dangerous mode. Further, when the security module 230 determines, based on a fact that the current temperature in the room exceeds the threshold 1, that smoke concentration exceeds a threshold 2, the security module 230 may determine the security level as the emergency mode based on the environment monitoring data. Optionally, the emergency mode is more dangerous than the dangerous mode.

In some embodiments, the security module 230 sends a security level determining result to the MCU 210. The MCU 210 may determine, based on the received security level determining result, whether a corresponding processing manner needs to be performed.

For example, the MCU 210 determines a current mode as the dangerous mode based on the received security level determining result, and the second electronic device 200 that obtains security authorization is allowed to perform unlocking. For example, the first electronic device 100 is allowed to indicate, by using the authorized second electronic device 200, the motor driving module 270 to drive the motor 271 to start, so as to implement unlocking.

For another example, the MCU 210 determines a current mode as the emergency mode based on the received security level determining result, and the motor driving module 270 may be directly indicated to drive the motor 271 to start, so as to implement unlocking.

In some embodiments, the security module 230 may be disposed in the MCU 210. In this case, a related operation performed by the security module 230 may be performed by the MCU 210.

The communication module 240 may provide a wireless communication solution that is applied to the first electronic device 100 and that includes Bluetooth (Bluetooth, BT), a wireless local area network (wireless local area network, WLAN) (for example, a wireless fidelity (wireless fidelity, Wi-Fi) network), a global navigation satellite system (global navigation satellite system, GNSS), frequency modulation (frequency modulation, FM), a near field communication (near field communication, NFC) technology, an infrared (infrared, IR) technology, or the like. The communication module 430 may be one or more components that integrate at least one communication processor module. The communication module 430 receives an electromagnetic wave through the antenna, performs frequency modulation and filtering processing on the electromagnetic wave signal, and sends a processed signal to the MCU 210. The communication module 240 may further receive a to-be-sent signal from the MCU 210, perform frequency modulation and amplification on the signal, and convert a processed signal into an electromagnetic wave for radiation through the antenna.

In some embodiments, the first electronic device 100 may obtain environment monitoring data by using the communication module 240. The first electronic device 100 may further establish a communication connection to the second electronic device 200 by using a communication module 240, to implement signal exchange.

For example, the first electronic device 100 receives, by using the communication module 240, an unlocking indication sent by the second electronic device 200. If the first electronic device 100 determines that a login account of the second electronic device 200 is authorized, the first electronic device 100 may indicate, based on the unlocking indication, the motor driving module 270 to drive the motor 271 to start, so as to implement unlocking.

The audio module 250 is configured to convert digital audio information into an analog audio signal for output, and is also configured to convert an analog audio input into a digital audio signal. The audio module 170 may be further configured to encode and decode an audio signal. In some embodiments, the audio module 170 may be disposed in the MCU 210, or some functional modules in the audio module 170 are disposed in the MCU 210.

In some embodiments, the first electronic device 100 may output prompt information by using the audio module 250. For example, the first electronic device 100 determines a current security level as the dangerous mode by using the security module 230. In this case, the prompt information may be sent by using the audio module 250, to prompt a nearby passerby to notice that there is a security risk in a room, a vehicle or the like in which the first electronic device 100 is currently located and that help is needed.

The memory 260 may be configured to store computer-executable program code. The executable program code includes instructions. The memory 260 may include a program storage area and a data storage area. The program storage area may store an operating system, an application function required by at least one function (for example, a fingerprint collection function or a host switching function), and the like. The data storage area may store data (for example, fingerprint template data) and the like created when the electronic device 100 is used. In addition, the memory 260 may include a high-speed random access memory, or may include a nonvolatile memory, for example, at least one magnetic disk storage device, a flash memory device, or a universal flash storage (universal flash storage, UFS). The MCU 210 runs the instructions stored in the memory 260 and/or the instructions stored in the memory disposed in the MCU 210, to perform various function applications of the first electronic device 100 and data processing.

The indicator 261 may be an indicator light, and may be configured to indicate a charging state and a power change, or may be configured to indicate a message, whether to perform unlocking, and the like.

The button 262 may be a mechanical button or a touch button. The first electronic device 100 may receive a button input, and generate a button signal input related to user setting and function control of the first electronic device 100. For example, the button includes a button configured to collect a password input by the user.

The motor driving module 270 is configured to drive the motor 271 to start, so as to implement unlocking or locking.

In some embodiments, the motor driving module 270 determines, based on an indication of the MCU 210, that a door lock needs to be opened. The motor driving module 270 may indicate the motor 270 to start, retract a bolt, and open the door lock. Alternatively, the motor driving module 270 determines, based on an indication of the MCU 210, that the door lock needs to be closed. The motor driving module 270 may indicate the motor 270 to start, release a bolt, and close the door lock.

The charging management module 280 is configured to receive a charging input from a charger. In some embodiments, the charging management module 280 may receive a charging input from a wired charger through the USB interface 290. The charging management module 280 may further supply power to the first electronic device 100 through the power management module 281 while charging the battery 282.

The power management module 281 is connected to the battery 282, the charging management module 280, and the MCU 210. The power management module 281 receives an input from the battery 282 and/or the charging management module 280, and supplies power to the MCU 210, the sensor module 220, the audio module 250, the memory 260, the communication module 240, and the like. The power management module 281 may be further configured to monitor parameters such as a capacity of the battery 282, a battery cycle count, and a battery health status (electric leakage or impedance).

In some embodiments, the power management module 281 and the charging management module 280 may alternatively be disposed in a same component.

The USB interface 290 is an interface that conforms to a USB standard specification, and may be a mini USB interface, a micro USB interface, a USB type-C interface, or the like. The USB interface 290 may be configured to connect to a charger to charge the first electronic device 100, or may be configured to exchange data between the first electronic device 100 and a peripheral device.

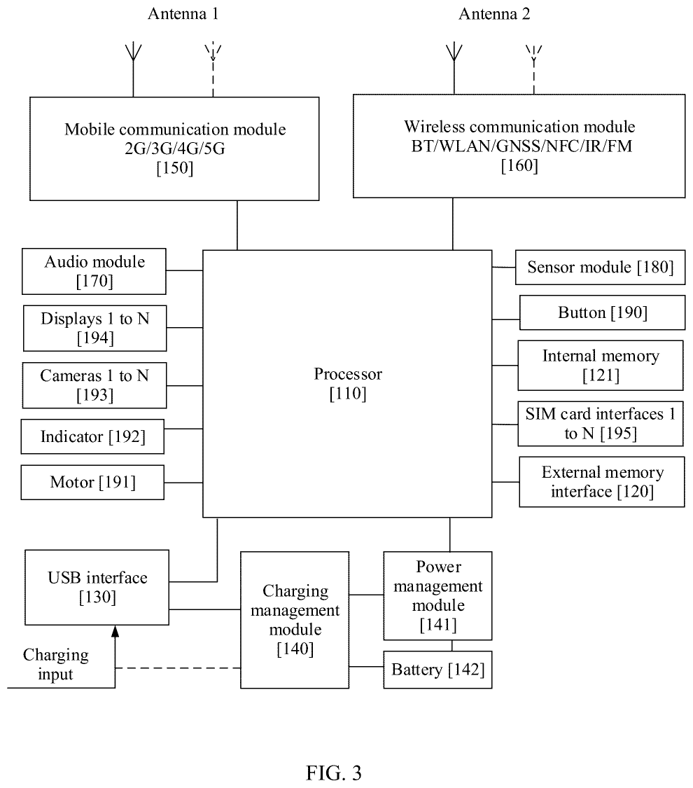

For example, FIG. 3 is a schematic diagram of a structure of a second electronic device 200.

The first electronic device 200 may include a processor 110, an external memory interface 120, an internal memory 121, a universal serial bus (universal serial bus, USB) interface 130, a charging management module 140, a power management module 141, a battery 142, an antenna 1, an antenna 2, a mobile communication module 150, a wireless communication module 160, an audio module 170, a sensor module 180, a button 190, a motor 191, an indicator 192, a camera 193, a display 194, a subscriber identification module (subscriber identification module, SIM) card interface 195, and the like.

It may be understood that the structure shown in this embodiment of this application does not constitute a specific limitation on the second electronic device 200. In some other embodiments of this application, the second electronic device 200 may include more or fewer components than those shown in the figure, or combine some components, or split some components, or have different component arrangements. The components shown in the figure may be implemented by hardware, software, or a combination of software and hardware.

The processor 110 may include one or more processing units. For example, the processor 110 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural-network processing unit (neural-network processing unit, NPU), and/or the like. Different processing units may be independent components, or may be integrated into one or more processors.

The controller may generate an operation control signal based on instruction operation code and a time sequence signal, to control instruction reading and instruction execution.

A memory may be further disposed in the processor 110, and is configured to store instructions and data. In some embodiments, the memory in the processor 110 is a cache. The memory may store instructions or data just used or cyclically used by the processor 110. If the processor 110 needs to use the instructions or the data again, the processor 110 may directly invoke the instructions or the data from the memory. This avoids repeated access and reduces waiting time of the processor 110, so that system efficiency is improved.

In some embodiments, the processor 110 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) interface, and/or the like.

The I2C interface is a bidirectional synchronous serial bus that includes a serial data line (serial data line, SDA) and a serial clock line (serial clock line, SCL). In some embodiments, the processor 110 may include a plurality of groups of I2C buses. The processor 110 may be separately coupled to a touch sensor, a charger, a flash, the camera 193, and the like through different I2C bus interfaces. For example, the processor 110 may be coupled to the touch sensor through the I2C interface, so that the processor 110 communicates with the touch sensor through the I2C bus interface, to implement a touch function of the second electronic device 200.

The MIPI interface may be configured to connect the processor 110 to peripheral components such as the display 194 and the camera 193. The MIPI interface includes a camera serial interface (camera serial interface, CSI), a display serial interface (display serial interface, DSI), and the like. In some embodiments, the processor 110 communicates with the camera 193 through the CSI interface, to implement a photographing function of the second electronic device 200. The processor 110 communicates with the display 194 through the DSI, to implement a display function of the second electronic device 200.

The USB interface 130 is an interface that conforms to a USB standard specification, and may be a mini USB interface, a micro USB interface, a USB type-C interface, or the like. The USB interface 130 may be configured to connect to a charger to charge the second electronic device 200, or may be configured to exchange data between the second electronic device 200 and a peripheral device, or may be configured to connect to a headset for playing audio through the headset. The interface may be further configured to connect to another electronic device like an AR device.

It can be understood that an interface connection relationship between modules illustrated in this embodiment of this application is merely an example for description, and does not constitute a limitation on the structure of the second electronic device 200. In some other embodiments of this application, the second electronic device 200 may alternatively use an interface connection manner different from that in the foregoing embodiment, or a combination of a plurality of interface connection manners.

The charging management module 140 is configured to receive a charging input from a charger. The charger may be a wireless charger or a wired charger. In some embodiments of wired charging, the charging management module 140 may receive a charging input from the wired charger through the USB interface 130. In some embodiments of wireless charging, the charging management module 140 may receive a wireless charging input by using a wireless charging coil of the second electronic device 200. The charging management module 140 may further supply power to the electronic device through the power management module 141 while charging the battery 142.

The power management module 141 is configured to connect to the battery 142, the charging management module 140, and the processor 110. The power management module 141 receives an input from the battery 142 and/or the charging management module 140, and supplies power to the processor 110, the internal memory 121, the display 194, the camera 193, the wireless communication module 160, and the like. The power management module 141 may be further configured to monitor parameters such as a battery capacity, a battery cycle count, and a battery health status (electric leakage or impedance). In some other embodiments, the power management module 141 may alternatively be disposed in the processor 110. In some other embodiments, the power management module 141 and the charging management module 140 may alternatively be disposed in a same component.

A wireless communication function of the second electronic device 200 may be implemented through the antenna 1, the antenna 2, the mobile communication module 150, the wireless communication module 160, the modem processor, the baseband processor, and the like.

The antenna 1 and the antenna 2 are configured to transmit and receive electromagnetic wave signals. Each antenna in the second electronic device 200 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that is applied to the second electronic device 200 and that includes 2G/3G/4G/5G or the like. The mobile communication module 150 may include at least one filter, a switch, a power amplifier, a low noise amplifier (low noise amplifier, LNA), and the like. The mobile communication module 150 may receive an electromagnetic wave through the antenna 1, perform processing such as filtering and amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1. In some embodiments, at least some functional modules in the mobile communication module 150 may be disposed in the processor 110. In some embodiments, at least some functional modules in the mobile communication module 150 and at least some modules of the processor 110 may be disposed in a same component.

The modem processor may include a modulator and a demodulator. The modulator is configured to modulate a to-be-sent low-frequency baseband signal into a medium-high frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor and then transmitted to the application processor. The application processor outputs a sound signal by using an audio device, or displays an image or a video on the display 194. In some embodiments, the modem processor may be an independent component. In some other embodiments, the modem processor may be independent of the processor 110, and is disposed in a same device as the mobile communication module 150 or another functional module.

The wireless communication module 160 may provide a wireless communication solution that is applied to the second electronic device 200 and that includes a wireless local area network (wireless local area network, WLAN) (for example, a wireless fidelity (wireless fidelity, Wi-Fi) network), Bluetooth (Bluetooth, BT), a global navigation satellite system (global navigation satellite system, GNSS), frequency modulation (frequency modulation, FM), a near field communication (near field communication, NFC) technology, an infrared (infrared, IR) technology, or the like. The wireless communication module 160 may be one or more components that integrate at least one communication processor module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert a processed signal into an electromagnetic wave through the antenna 2 for radiation.

In some embodiments, in the second electronic device 200, the antenna 1 and the mobile communication module 150 are coupled, and the antenna 2 and the wireless communication module 160 are coupled, so that the second electronic device 200 can communicate with a network and another device by using a wireless communication technology. The wireless communication technology may include a global system for mobile communications (global system for mobile communications, GSM), a general packet radio service (general packet radio service, GPRS), code division multiple access (code division multiple access, CDMA), wideband code division multiple access (wideband code division multiple access, WCDMA), time-division code division multiple access (time-division code division multiple access, TD-SCDMA), long term evolution (long term evolution, LTE), BT, a GNSS, a WLAN, NFC, FM, an IR technology, and/or the like. The GNSS may include a global positioning system (global positioning system, GPS), a global navigation satellite system (global navigation satellite system, GNSS), a BeiDou navigation satellite system (BeiDou navigation satellite system, BDS), a quasi-zenith satellite system (quasi-zenith satellite system, QZSS), and/or a satellite based augmentation system (satellite based augmentation system, SBAS).

The second electronic device 200 implements a display function by using the GPU, the display 194, the application processor, and the like. The GPU is a microprocessor for image processing, and connects the display 194 to the application processor. The GPU is configured to: perform mathematical and geometric computation, and render an image. The processor 110 may include one or more GPUs, which execute program instructions to generate or change display information.

The display 194 is configured to display an image, a video, and the like. The display 194 includes a display panel. The display panel may be a liquid crystal display (liquid crystal display, LCD), an organic light-emitting diode (organic light-emitting diode, OLED), an active-matrix organic light-emitting diode (active-matrix organic light-emitting diode, AMOLED), a flexible light-emitting diode (flexible light-emitting diode, FLED), a mini-LED, a micro-LED, a micro-OLED, a quantum dot light-emitting diode (quantum dot light-emitting diode, QLED), or the like. In some embodiments, the second electronic device 200 may include one or N displays 194, where N is a positive integer greater than 1.

The camera 193 may be configured to capture a static image or a video. An optical image of an object is generated through a lens, and is projected onto a photosensitive element. The photosensitive element may be a charge-coupled device (charge-coupled device, CCD) or a complementary metal-oxide-semiconductor (complementary metal-oxide-semiconductor, CMOS) phototransistor. The light-sensitive element converts an optical signal into an electrical signal, and then transmits the electrical signal to the ISP to convert the electrical signal into a digital image signal. The ISP outputs the digital image signal to the DSP for processing. The DSP converts the digital image signal into an image signal in a standard format like RGB or YUV. In some embodiments, the second electronic device 200 may include one or N cameras 193, where N is a positive integer greater than 1.

In some embodiments, the second electronic device 200 collects a face image of a user by using the camera 193, and sends the face image to the server 300 (for example, the second server) by using the mobile communication module 150 or the wireless communication module 160. In this way, subsequently, the first electronic device 100 or another electronic device associated with a same account with the first electronic device 100 may obtain the face image from the server 300, and determine an identity of a user who indicates to open the first electronic device 100 (for example, indicates to unlock the first electronic device). This ensures environment security in the first electronic device 100.

The external memory interface 120 may be configured to connect to an external storage card, for example, a micro SD card, to extend a storage capability of the second electronic device 200. The external storage card communicates with the processor 110 through the external memory interface 120, to implement a data storage function. For example, files such as music and videos are stored in the external storage card.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (for example, audio data and a phone book) and the like created when the second electronic device 200 is used. In addition, the internal memory 121 may include a high-speed random access memory, or may include a nonvolatile memory, for example, at least one magnetic disk storage device, a flash memory device, or a universal flash storage (universal flash storage, UFS). The processor 110 runs the instructions stored in the internal memory 121 and/or the instructions stored in the memory disposed in the processor, to perform various function applications of the second electronic device 200 and data processing.

The audio module 170 is configured to convert digital audio information into an analog audio signal for output, and is also configured to convert an analog audio input into a digital audio signal. The audio module 170 may be further configured to encode and decode an audio signal. In some embodiments, the audio module 170 may be disposed in the processor 110, or some functional modules in the audio module 170 are disposed in the processor 110. The second electronic device 200 may perform, for example, music playing or recording by using the audio module 170. The audio module 170 may include a speaker, a receiver, a microphone, a headset jack, an application processor, and the like to implement an audio function.

The sensor module 180 may include a pressure sensor, a gyroscope sensor, a barometric pressure sensor, a magnetic sensor, an acceleration sensor, a distance sensor, an optical proximity sensor, a fingerprint sensor, a temperature sensor, a touch sensor, an ambient light sensor, a bone conduction sensor, and the like.

The pressure sensor is configured to sense a pressure signal, and can convert the pressure signal into an electrical signal. In some embodiments, the pressure sensor may be disposed on the display 194. There are many types of pressure sensors such as a resistive pressure sensor, an inductive pressure sensor, and a capacitive pressure sensor. The capacitive pressure sensor may include at least two parallel plates made of conductive materials. When force is applied to the pressure sensor, capacitance between electrodes changes. The second electronic device 200 determines pressure intensity based on the change of the capacitance. When a touch operation is performed on the display, the second electronic device 200 detects intensity of the touch operation by using the pressure sensor. The second electronic device 200 may also calculate a touch location based on a detection signal of the pressure sensor. In some embodiments, touch operations that are performed at a same touch location but have different touch operation intensity may correspond to different operation instructions. For example, when a touch operation whose touch operation intensity is less than a first pressure threshold is performed on an SMS message application icon, an instruction for viewing an SMS message is executed. When a touch operation whose touch operation intensity is greater than or equal to a first pressure threshold is performed on an SMS message application icon, an instruction for creating a new SMS message is executed.

The touch sensor is also referred to as a “touch component”. The touch sensor may be disposed on the display 194, and the touch sensor and the display 194 form a touchscreen, which is also referred to as a “touch screen”. The touch sensor is configured to detect a touch operation performed on or near the touch sensor. The touch sensor may transfer the detected touch operation to the application processor to determine a type of the touch event. A visual output related to the touch operation may be provided on the display 194. In some other embodiments, the touch sensor may alternatively be disposed on a surface of the second electronic device 200, or disposed in a location different from the display 194.

The button 190 includes a power button, a volume button, and the like. The button 190 may be a mechanical button, or may be a touch button. The second electronic device 200 may receive a button input, and generate a button signal input related to user setting and function control of the second electronic device 200.

The motor 191 may generate a vibration prompt. The motor 191 may be configured to provide an incoming call vibration prompt and a touch vibration feedback. For example, touch operations performed on different applications (for example, photographing and audio playback) may correspond to different vibration feedback effects. The motor 191 may also correspond to different vibration feedback effects for touch operations performed on different areas of the display 194. Different application scenarios (for example, a time reminder, information receiving, an alarm clock, and a game) may alternatively correspond to different vibration feedback effects. A touch vibration feedback effect may be further customized.

The indicator 192 may be an indicator light, and may be configured to indicate a charging state and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the second electronic device 200. The second electronic device 200 may support one or N SIM card interfaces, where N is a positive integer greater than 1.

In the following embodiments, the unlocking method provided in embodiments of this application is described by using an example in which the first electronic device 100 is a smart door lock (for example, a smart room door lock or a smart car door lock), the second electronic device 200 is a mobile phone, and the server 300 includes a first server and a second server.

In some embodiments, one or more sensors that can monitor an environment are included in an environment in which a smart door lock is closed (for example, in a room where a smart door lock is installed, or in a vehicle where a smart door lock is installed), and the sensor may be a dedicated environment monitoring sensor, or may be a sensor installed on a device included in the environment.

For example, the smart door lock is a smart room door lock, and a room in which a smart room door lock is closed includes one or more of a temperature sensor for monitoring a room temperature, a smoke sensor for monitoring smoke concentration in the room, a camera for monitoring, a water immersion sensor for monitoring whether water immersion occurs in the room, and the like. For another example, the smart door lock is a smart car door lock, and a vehicle in which a smart car door lock is closed includes one or more of a temperature sensor for monitoring a temperature in a vehicle, a smoke sensor for monitoring smoke concentration in the vehicle, a camera for monitoring, and the like.

In some embodiments, the smart door lock can establish a communication connection to one or more sensors that can monitor an environment and that are included in the environment or to a device in which the sensors are located, to obtain environment monitoring data monitored by each sensor. The smart door lock can determine a current security level based on the obtained environment monitoring data. The security level includes, for example, one or more of a normal mode, a dangerous mode, and an emergency mode. The normal mode indicates that a current environment in which a smart door lock is closed is safe, and the dangerous mode and the emergency mode indicate that there is a risk in a current environment in which a smart door lock is closed. Different security levels correspond to different danger degrees. For example, the danger degrees are the normal mode, the dangerous mode, and the emergency mode from low to high. In this case, the smart door lock can subsequently adopt a corresponding processing manner based on different risk levels.

In some other embodiments, a central control device like a smart home control panel (which may also be another central control device in a room) and a vehicle central control device is configured in an environment in which a smart door lock is closed. The central control device may obtain environment monitoring data that is sent by using one or more sensors that are included in the environment in which the smart door lock is closed and that can monitor the environment or by using a device in which the sensors are located. Then, the central control device sends the environment monitoring data to the smart door lock, and the smart door lock determines a security level and a corresponding processing manner. Alternatively, the central control device determines a security level based on the environment monitoring data. Then, the central control device sends a security level determining result to the smart door lock, and the smart door lock determines a corresponding processing manner based on the obtained determined security level result.

In some embodiments, when a smart door lock is in a locked state (for example, a bolt has been released), the smart door lock determines or obtains a current security level. Then, based on the security level, the smart door lock determines whether to perform a corresponding processing manner, for example, retracting the bolt, to implement unlocking. Alternatively, a central control device may directly determine a corresponding processing manner after determining a security level. Then, the central control device sends a corresponding indication signal to the smart door lock based on the processing manner, for example, indicating the smart door lock to start security authorization-based unlocking, or directly indicating the smart door lock to perform unlocking.

It should be noted that, in the following embodiments, an unlocking method provided in embodiments of this application is described by using an example in which a smart door lock determines a security level and a corresponding processing manner.

For example, FIG. 4 is a schematic flowchart of a security level determining method according to an embodiment of this application. As shown in FIG. 4, the method includes the following steps.

S401: A smart door lock obtains environment monitoring data.

In some embodiments, as described above, the smart door lock can obtain environment monitoring data monitored by each sensor in an environment in which the smart door lock is closed. In addition, if the smart door lock includes a sensor, the smart door lock can further obtain environment monitoring data detected by the sensor of the smart door lock.

S402: The smart door lock determines whether a condition 1 is met. If the condition 1 is met, S403 is performed; or if the condition 1 is not met, S401 is performed.

S403: The smart door lock determines a security level as a dangerous mode.

In some embodiments, in step S402 and step S403, the condition 1 is a security level determining condition. Optionally, if the smart door lock determines that current environment monitoring data meets the condition 1, the smart door lock may determine the security level as the dangerous mode (that is, step S403 is performed). If the smart door lock determines that current environment monitoring data does not meet the condition 1, the smart door lock may continuously monitor the environment in which the smart door lock is closed, to obtain the environment monitoring data (that is, step S401 is performed).

Generally, the environment monitoring data changes in some risk scenarios. Whether there is a risk of danger currently can be determined based on the environment monitoring data, and then the security level can be determined.

For example, an ambient temperature rises in a fire. In this case, in an example 1 shown in Table 1, the condition 1 may be, for example, that a temperature is greater than a threshold 1. If the threshold 1 is 50° C., when the smart door lock determines, based on the obtained environment monitoring data, that a current indoor/in-vehicle temperature is greater than 50° C., the smart door lock may determine that there is a fire risk, and determine the security level as the dangerous mode. For another example, smoke generates in a fire, and smoke concentration rises. In this case, in an example 2 shown in Table 1, the condition 1 may be that the smoke concentration is greater than a threshold 3. In this case, when the smart door lock determines that current indoor/in-vehicle smoke concentration is greater than the threshold 3, the smart door lock may determine that there is the fire risk, and determine the security level as the dangerous mode.

TABLE 1

| Example | Conditions | Content |
|---|---|---|
| Example 1 | Condition 1 | The temperature is greater than the threshold 1 |
| | Condition 2 | The temperature is greater than a threshold 2, and the threshold 2 |
| | | is greater than threshold 1 |
| | Condition 3 | The smoke concentration is greater than the threshold 3 |
| Example 2 | Condition 1 | The smoke concentration is greater than the threshold 3 |
| | Condition 2 | The smoke concentration is greater than a threshold 4, and the |
| | | threshold 4 is greater than the threshold 3 |
| | Condition 3 | The temperature is greater than the threshold 1 |
| . . . | . . . | . . . |

It should be noted that the conditions and descriptions of the conditions shown in Table 1 are only examples, and there are other corresponding conditions for judging other dangers. For example, in a water immersion danger scenario, the condition 1 may be that environment monitoring data monitored by a water immersion sensor is greater than a preset threshold. This is not described one by one in this embodiment of this application.

S404: The smart door lock determines whether the condition 2 is met.

S405: The smart door lock determines the security level as an emergency mode.

In some embodiments, in step S404 and step S405, the condition 2 is a security level determining condition. In some cases, the smart door lock determines, based on the environment monitoring data, that a danger degree currently exceeds a danger degree corresponding to the dangerous mode, and may determine the security level as the emergency mode.

For example, in a fire scenario shown in the step S403, the condition 1 is that the temperature is greater than 50° C. As shown in Table 1, the condition 2 may be preset to be that the temperature is greater than the threshold 2, and the threshold 2 is greater than the threshold 1. For example, the threshold 2 is 70° C. In view of this, the smart door lock determines, based on the monitored ambient temperature, that a current ambient temperature is greater than 70° C., and can directly determine the security level as the emergency mode.

S406: The smart door lock determines whether the condition 3 is met.

In some embodiments, a plurality of types of environment monitoring data may change in a dangerous scenario. In this case, the smart door lock can determine the dangerous scenario based on the plurality of types of environment monitoring data.

For example, when the smart door lock determines a current security level as the dangerous mode, and determines, based on the obtained environment monitoring data, that a current environment meets the condition 3, the smart door lock may upgrade the security level to the emergency mode. The emergency mode is more dangerous than the dangerous mode. As shown in the example 1 in Table 1, the condition 3 is that the smoke concentration is greater than the threshold 3. In this case, when the smart door lock determines that the ambient temperature is greater than the threshold 1 and the smoke concentration exceeds the threshold 3, the smart door lock may determine the current security level as the emergency mode. That is, the smart door lock may determine the security level based on one or more conditions, to ensure accuracy of the determined security level and reduce a hazard caused by an occurring risk.

In this way, according to the foregoing method, the smart door lock can determine the security level based on the environment monitoring data, and then can perform corresponding different processing manners, to effectively avoid occurrence of a danger and reduce a risk.

In some embodiments, the smart door lock first determines, based on the obtained environment monitoring data, whether a current scenario is a preset dangerous scenario. Then, if the smart door lock determines that the smart door lock is currently in the preset dangerous scenario, the smart door lock determines the security level based on a security level determining condition corresponding to the preset dangerous scenario. The preset dangerous scenario includes, for example, a fire scenario, a flood scenario, an individual activity scenario of a child, and a scenario of disease in the elderly.

For example, the smart door lock determines, based on the environment monitoring data such as the ambient temperature, that an increase of the ambient temperature in a preset time period is greater than a preset threshold, and further determines a current scenario as a fire scenario in the preset dangerous scenario. In this case, the smart door lock can determine the security level based on the condition 1, the condition 2, and the condition 3 in the example 1 or the example 2 shown in Table 1.

For another example, the smart door lock determines, based on camera monitoring data in the environment monitoring data, that there is no person in a driver's seat in a vehicle and there is a child in a child seat. In this case, the smart door lock may determine a current scenario as the individual activity scenario of a child in the preset dangerous scenario. For example, the smart door lock determines the security level as the dangerous mode. Further, in view of this, when the smart door lock determines, based on the environment monitoring data, that a current temperature in the vehicle exceeds the preset threshold, the smart door lock may determine the security level as the emergency mode.

For another example, the smart door lock determines, based on camera monitoring data in the environment monitoring data, that there is only one elderly person in a room, and a time period in which the elderly person falls to the ground exceeds preset duration. In this case, the smart door lock may determine a current scenario as the scenario of disease in the elderly in the preset dangerous scenario, and determine the security level as the emergency mode.

In some other embodiments, a central control device is included in the environment in which the smart door lock is closed. In this case, the central control device may alternatively determine, based on the environment monitoring data, whether the current environment in which the smart door lock is closed is in a preset dangerous scenario. If the central control device determines that the current environment in which the smart door lock is closed is in the preset dangerous scenario, the central control device may determine a corresponding security level determining condition, and then determine the security level. Then, the central control device sends the security level to the smart door lock, so that the smart door lock can perform a corresponding processing manner based on the security level. Alternatively, the central control device determines a corresponding processing manner based on the security level, and then directly sends an indication signal to the smart door lock, to indicate the smart door lock to perform the corresponding processing manner.

For example, in the fire scenario in the preset dangerous scenario in the foregoing example, a smart home control panel (or another central control device in a room) determines a current scenario as the fire scenario based on the obtained environment monitoring data. In this case, it may be determined that the corresponding security level determining condition includes the condition 1, the condition 2, and the condition 3 in the example 1 shown in Table 1, and then a corresponding security level is determined.

Alternatively, in the individual activity scenario of a child in the preset dangerous scenario in the foregoing example, a vehicle central control device may determine a current scenario as the individual activity scenario of a child based on the environment monitoring data. Then, the vehicle central control device may determine a corresponding security level.

Alternatively, in the scenario of disease in the elderly in the preset dangerous scenario in the foregoing example, a smart home control panel (or another central control device in a room) may determine a current scenario as the scenario of disease in the elderly based on the obtained environment monitoring data. Then, the smart home control panel may determine a corresponding security level.

In this way, different preset dangerous scenario determining methods are preset in the smart door lock, and security level determining conditions corresponding to different preset dangerous scenarios are preset. This enriches scenarios to which the security level determining method can be applied, implements subsequent unlocking based on the security level, and ensures that damage caused by a danger can be reduced in different preset dangerous scenarios, thereby effectively improving user experience.

In some embodiments, the smart door lock may further obtain user monitoring data monitored by a wearable device. In this case, the smart door lock may also determine a current security level based on the obtained user monitoring data. The wearable device may be a wearable device in the environment in which the smart door lock is closed, and the user monitoring data obtained by the smart door lock is monitoring data of a user in the current environment in which the smart door lock is closed.

For example, the smart door lock obtains heart rate data sent by a smartwatch, and determines that a current heart rate of the user is abnormal. Then the smart door lock may determine the security level as the emergency mode.

It should be noted that the wearable device may further monitor other more user monitoring data such as blood pressure and a blood oxygen level. In this case, the smart door lock may also determine the security level with reference to a plurality of pieces of user monitoring data. This is not described one by one in this embodiment of this application.

For another example, the smart door lock may determine the current security level with reference to the environment monitoring data and the user monitoring data. For example, the smart door lock determines, based on the environment monitoring data, that the user falls to the ground, and determines, based on the user monitoring data, that the heart rate of the user is abnormal. Then, the smart door lock may determine the current security level as the emergency mode.

Optionally, the smart door lock may further determine the security level with reference to user data. The user data is data of a user associated with a first electronic device, for example, a family member of an owner of the first electronic device. The user data includes, for example, disease data, an age, and a gender of the user. For example, the smart door lock determines the security level as the dangerous mode based on the environment monitoring data and/or the user monitoring data. However, the smart door lock may directly determine the security level as the emergency mode with reference to the disease data of the user, to avoid causing a danger to a sick user.

In some other embodiments, a central control device is included in the environment in which the smart door lock is closed. In this case, the central control device may also obtain one or more of the environment monitoring data, the user monitoring data, and the user data, to determine the security level. Then, the central control device sends the security level to the smart door lock, so that the smart door lock can perform a corresponding processing manner based on the security level. Alternatively, the central control device determines a corresponding processing manner based on the security level, and then directly sends an indication signal to the smart door lock, to indicate the smart door lock to perform the corresponding processing manner.

The foregoing describes how the smart door lock or the central control device determines the security level based on the environment monitoring data and the like. The following describes processing manners performed by the smart door lock in different security levels.

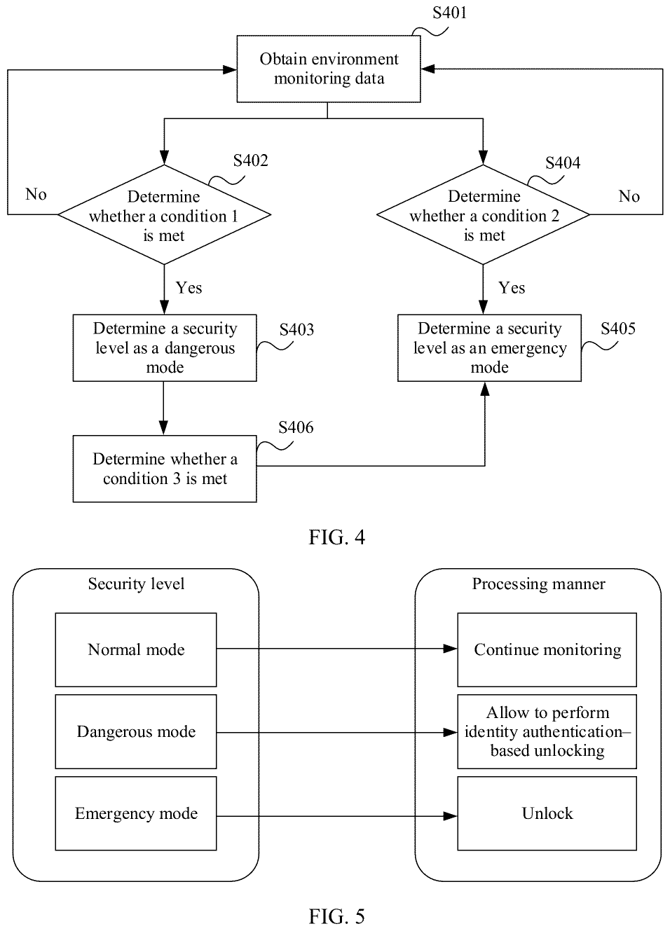

In some embodiments, as shown in FIG. 5, the security level described above may include one or more of a normal mode, the dangerous mode, and the emergency mode. The normal mode indicates that the current environment in which the smart door lock is closed is safe. In this case, a corresponding processing manner may be continuing monitoring, to continue obtaining data such as the environment monitoring data. The dangerous mode indicates that there is a danger in the current environment in which the smart door lock is closed. In this case, a corresponding processing manner is to allow security authorization-based unlocking, that is, allow conditional unlocking to ensure security. The emergency mode indicates that there is a big danger in the current environment in which the smart door lock is closed. In this case, a corresponding processing manner is unlocking, that is, directly unlocking, to reduce damage caused by the danger.

Optionally, the security authorization-based unlocking indicates that, when it is determined that there is a danger in the current environment in which the smart door lock is closed, a second electronic device of a stranger is allowed to establish a connection to the smart door lock, and after it is determined that a login account of the second electronic device is authorized, the second electronic device is allowed to indicate the smart door lock to perform unlocking. This reduces a risk, and ensures safety of property in the environment in which the smart door lock is closed. However, when it is determined that there is no danger in the current environment in which the smart door lock is closed, a second electronic device of a stranger is not allowed to establish a connection to the smart door lock, and the second electronic device is not allowed to indicate the smart door lock to perform unlocking. Optionally, the second electronic device of the stranger is an electronic device that does not establish a connection, an account binding relationship, a trust relationship, or the like to the smart door lock before the second electronic device establishes a connection during the security authorization-based unlocking. Therefore, the second electronic device generally cannot establish a connection to the smart door lock without permission of the smart door lock. In this embodiment of this application, when it is determined that there is a danger in the current environment in which the smart door lock is closed, the smart door lock may allow establishing a connection to the second electronic device without being determined by an owner, to avoid a danger caused when the owner is not near the smart door lock.

Generally, during account registration of an application, an identity of a registered user is authenticated in a plurality of manners. After identity authentication on the user succeeds, account registration may be completed. For example, the second electronic device completes account registration by creating an account name and a corresponding login password. Optionally, during account registration, account security may be further ensured in a plurality of manners such as mobile number authentication, real-name authentication, and facial recognition. In this case, when the second electronic device subsequently logs in to the account, an identity of a corresponding login user may be determined. Further, the second electronic device authorizes the login account, so that security can be ensured, and security authorization-based unlocking is implemented. It should be noted that, for an account registration process, refer to the conventional technology. Details are not described in this embodiment of this application.

In some embodiments, when determining the security level as the emergency mode, the smart door lock may alternatively allow the user to perform security authorization-based unlocking, to avoid a risk caused by an automatic unlocking failure.

In some other embodiments, if the smart door lock determines a current security level as a mode other than an abnormal mode, the smart door lock may directly perform unlocking, to minimize damage caused by a danger.

In still some other embodiments, when determining that there is a risk of damage to the smart door lock, the smart door lock may alternatively indicate to directly perform unlocking, to avoid an unlocking exception after the damage occurs.

For example, if the smart door lock determines, by using a sensor of the smart door lock, that a current temperature is higher than the preset threshold, there is a risk of damage to the smart door lock due to a high temperature. In this case, the smart door lock may directly indicate to retract a bolt, to implement unlocking.

In some embodiments, if the smart door lock determines to allow security authorization-based unlocking, access of another electronic device (for example, a second electronic device like a mobile phone) may be allowed. In this way, a user (not an owner of the smart door lock) may perform authorization on a login account of the second electronic device by using the accessed second electronic device. After authorization on the login account succeeds, the second electronic device indicates the smart door lock to perform unlocking.

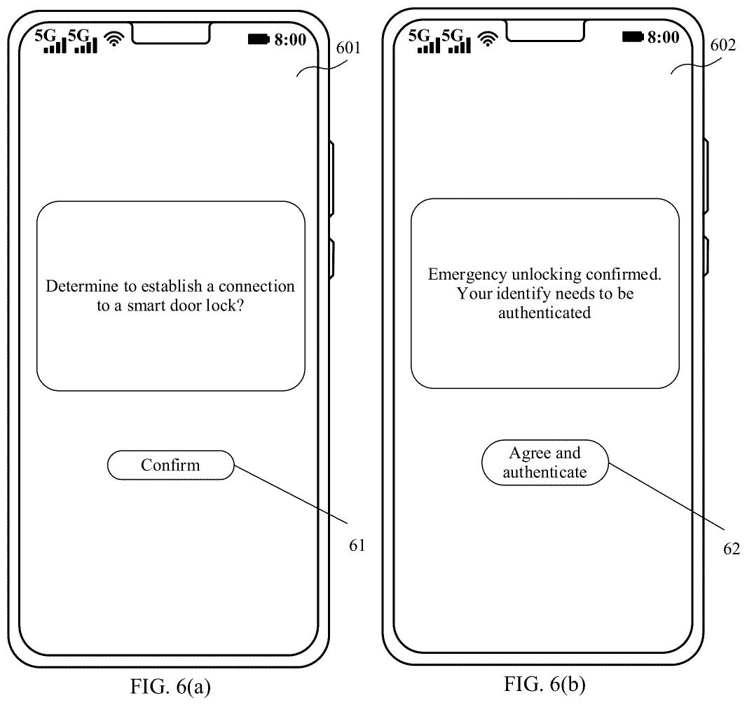

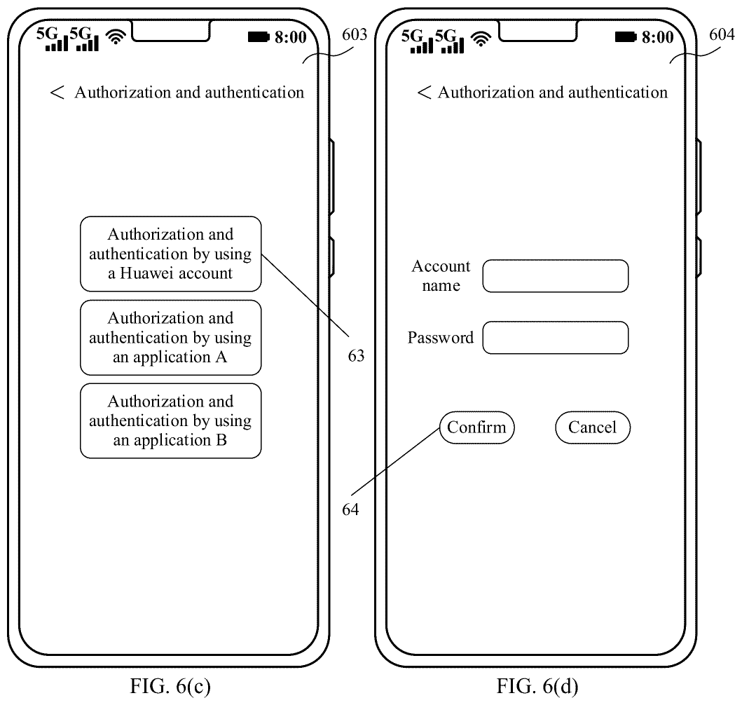

For example, the smart door lock supports a proximity detection function. After it is determined to enable security authorization-based unlocking, for example, the user touches an NFC sensing area of the smart door lock by using the mobile phone, the mobile phone may establish a communication connection to the smart door lock. On an interface 601 shown in FIG. 6(a), the mobile phone displays prompt information, to prompt the user to determine whether to allow establishing a connection to the smart door lock. For example, after detecting an operation of tapping a confirm control 61 by the user, the mobile phone may establish a communication connection to the smart door lock.

Then, the smart door lock may confirm an authorization status of the mobile phone. On an interface 602 shown FIG. 6(b), the mobile phone displays prompt information, to prompt the user whether emergency unlocking is being performed and whether it is determined to allow performing identity authentication on the user. For example, after detecting an operation of tapping an agree and authenticate control 62 by the user, the mobile phone may confirm to start authorization and authentication.

Optionally, a user identity is authenticated during creation of an account like a Huawei account or an account of a specific application (for example, WeChat® or Alipay®). After identity authentication succeeds, account creation is completed. For example, real-name authentication is performed on the user based on identity document information, face information, and a real name of the user to complete account creation. For another example, account creation is completed in an authentication mode like mobile number SMS authentication (that is, real-name authentication may not be performed on an account). In this case, during security authorization-based unlocking, the mobile phone may alternatively complete identity authentication on the user by indicating the user to log in to a corresponding account.

It should be noted that a real-name authentication account has higher security, and the user identity authenticated by using the real-name authentication account can better ensure security in the environment in which the smart door lock is closed. However, some users may not create real-name authentication accounts. In this embodiment of this application, the second electronic device may alternatively be allowed to indicate, after logging in to an account on which real-name authentication is not performed, the smart door lock to perform unlocking, to ensure that a possible risk in the environment in which the smart door lock is closed is timely resolved.

For example, on an interface 603 shown in FIG. 6(c), the user may choose, based on a registered account of the user, to perform authorization and authentication by using a Huawei account, an application A (for example, WeChat®), or an application B (for example, Alipay®). If the mobile phone detects an operation performed on a control 63, and determines that the user indicates to perform authorization and authentication by using the Huawei account, an interface 604 shown in FIG. 6(d) may be displayed. On the interface 604, the mobile phone may receive an account name and a password that are input by the user. After detecting an operation of tapping a confirm control 64 by the user, the mobile phone determines that the user completes a login operation on the Huawei account. Then, the mobile phone may perform authentication on the account name and the password.

Optionally, during authentication on a login account, the mobile phone (namely, the second electronic device) may send an account name and a password to a corresponding server (for example, the first server) for authentication. If the mobile phone determines that the user performs authorization and authentication by using a Huawei account, the mobile phone may send the obtained name and password of the Huawei account to a Huawei server. Alternatively, if the mobile phone determines that the user performs authorization and authentication by using an account of a third-party application (for example, WeChat® and Alipay®), the mobile phone may send the obtained account name and password to a corresponding third-party application server (for example, a WeChat® server or an Alipay® server).

Then, the corresponding server (for example, the first server) authenticates the obtained account name and password, and sends an authentication result to the mobile phone. If it is determined that authentication succeeds, an authentication success signal or an authorization confirmation signal may be fed back. For example, if the first server determines that the obtained password is the same as a preset password corresponding to the account name, the first server may determine that authentication succeeds. Alternatively, the mobile phone may locally complete authentication on the account name and the password. For example, if it is determined that a local preset password is the same as a password input by the user, it may be determined that authentication succeeds.

Correspondingly, the mobile phone may receive an authentication success signal or an authorization confirmation signal sent by the first server. When the mobile phone determines, based on the authentication success signal or the authorization confirmation signal, that identity authentication on the user succeeds (that is, the login account is authorized), the mobile phone may send the authentication success signal to the smart door lock. Optionally, the authentication success signal carries authorization confirmation information, for example, a key or check code. The authorization confirmation information is information determined by the first server according to a preconfigured rule corresponding to security authorization-based unlocking. In this case, after receiving the authorization confirmation information, the smart door lock may determine, according to the preset rule, that the mobile phone is a mobile phone whose login account is authorized. This can avoid false unlocking of the smart door lock caused by sending the authentication success signal by an unauthorized electronic device.

Alternatively, when the mobile phone touches the smart door lock, the mobile phone may obtain, from the smart door lock, an ID of the smart door lock and a communication address of a second server for managing the smart door lock. In this case, a login authentication request (for example, a request carrying the account name and the password) sent by the mobile phone to the first server may further carry the ID of the smart door lock and the communication address of the second server. Then, after the first server determines that authentication on identity authentication information associated with a login account of the mobile phone succeeds, the first server may determine a corresponding second server based on the obtained communication address of the second server, and send, to the second server, an authentication success signal indicating that authentication on the login account of the mobile phone succeeds. The ID of the smart door lock and an ID of the mobile phone may also be carried in the authentication success signal. When the first server receives the login authentication request sent by the mobile phone, the first server may determine the ID of the mobile phone. After receiving the authentication success signal, the second server may determine a corresponding smart door lock based on the ID of the smart door lock, and forward the authentication success signal to the determined smart door lock. The ID of the mobile phone is carried in the forwarded authentication success signal. Therefore, after receiving the authentication success signal forwarded by the second server, the smart door lock may determine, based on the ID of the mobile phone in the authentication success signal, that the received ID of the mobile phone and an ID of a currently connected mobile phone (where the ID of the mobile phone can be obtained when the smart door lock establishes a connection to the mobile phone) are the same, and further determine that authorization on the login account of the mobile phone is completed. The ID of the smart door lock may be a unique identifier of the smart door lock, and is used to distinguish different smart door locks. The ID of the mobile phone may be a unique identifier of the mobile phone, and is used to distinguish different mobile phones.

Optionally, in the foregoing implementation in which the smart door lock determines authorization on the login account of the mobile phone based on the authentication success signal forwarded by the second server, if the first server and the second server are a same server, after the mobile phone receives the communication address of the second server that is sent by the smart door lock, the mobile phone may determine that the second server is also a server for authenticating the login account. In this case, when the mobile phone may send the authentication request to the first server (namely, the second server), the authentication request may carry the ID of the smart door lock, but does not need to carry the communication address of the second server. The first server may determine, based on the ID of the smart door lock, a smart door lock managed by the first server, to directly send the authentication success signal to the smart door lock. Alternatively, the authentication request sent by the mobile phone to the first server (namely, the second server) still carries the ID of the smart door lock and the communication address of the second server. The first server determines, based on the communication address of the second server, that the first server is a server for managing the smart door lock, and then directly sends the authentication success signal to the smart door lock based on the ID of the smart door lock. For example, both the smart door lock and the mobile phone have joined the Huawei ecosystem, and both the first server and the second server are Huawei servers. After confirming that authorization on the login account of the mobile phone succeeds, the Huawei server may determine a corresponding smart door lock based on the received ID of the smart door lock that is sent by the mobile phone, and directly send the authentication success signal to the smart door lock.

In some embodiments, after completing authentication on identity information associated with the login account of the mobile phone, the first server may send login information of the login account to the second server. For example, in the foregoing manner, the first server obtains information about the second server from the received authentication request sent by the mobile phone, determines the second server based on the information about the second server, and sends the login information of the login account to the second server. Alternatively, after determining that authentication succeeds, the mobile phone may send the login information to the second server. In this case, the second server may store the obtained login information of the login account of the mobile phone.

Subsequently, the owner of the smart door lock may obtain the login information. The login information includes, for example, login account information (for example, a Huawei account name, a WeChat® account name, or an Alipay® account name corresponding to a login account used by the user), authorization request time, and the ID of the smart door lock.

For example, the smart door lock has joined the Huawei ecosystem, and the second server is a Huawei server. The owner of the smart door lock may determine login information of an authorized login account by connecting a mobile phone of the owner to the Huawei server. Alternatively, the smart door lock requests the second server to obtain the login information, and the owner may view the login information by using the smart door lock. Alternatively, the smart door lock requests the second server to obtain the login information, connects a mobile phone of the owner to the smart door lock through Bluetooth, and views the login information by using the mobile phone. Alternatively, the second server sends the login information to the smart door lock. Alternatively, the second server sends the login information to an electronic device (for example, a mobile phone of the owner) associated with the owner of the smart door lock.

It should be noted that, in some scenarios, if the mobile phone completes authorization and authentication by logging in to a Huawei account, and the smart door lock has joined the Huawei ecosystem, correspondingly, both the first server and the second server may be Huawei servers. In this case, the first server may also perform an operation performed by the second server, for example, allowing the smart door lock to query the login information. Details are not described herein again.

In this way, an identity of a user who operates the smart door lock this time may be determined by authorizing the login account of the mobile phone, to ensure security in the environment in which the smart door lock is closed to some extent, and avoid artificial damage. In addition, traceability of security authorization-based unlocking can be increased, so that the owner of the smart door lock can determine a user who performs security authorization-based unlocking.

In some embodiments, in the scenario shown in FIG. 6(a) to FIG. 6(d), if the mobile phone has logged in to the Huawei account, the user does not need to input the account name and the password again. Instead, the user may directly confirm identity authentication for logging in to the Huawei account in a secure login mode configured in the mobile phone, for example, by using a mobile number.

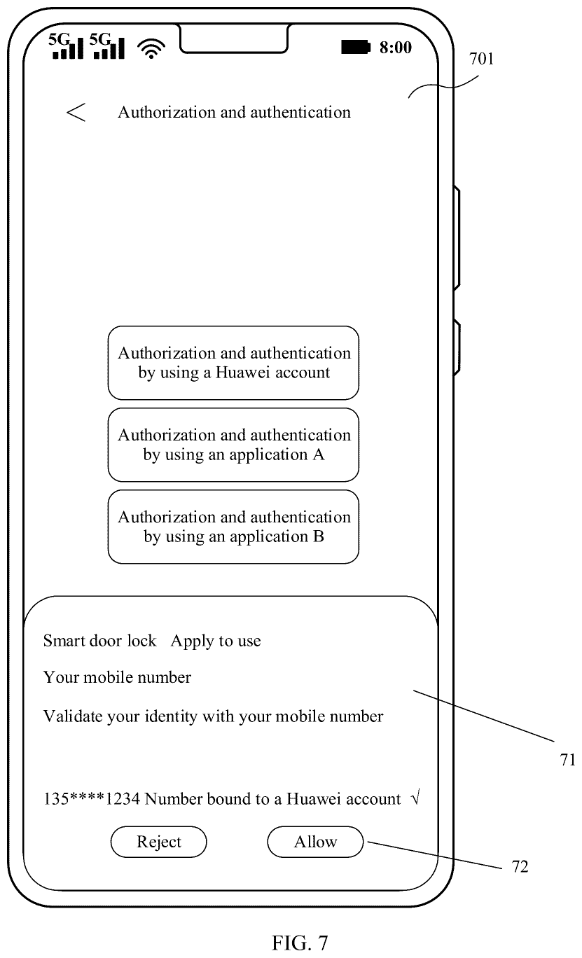

For example, the mobile phone detects, on the interface 603 shown in FIG. 6(c), the operation of tapping the control 63 by the user, and confirms that authorization and authentication are completed by using the Huawei account. In addition, the mobile phone confirms that the mobile phone has logged in to the Huawei account. In this case, the mobile phone may display an interface 701 shown in FIG. 7, and complete authorization and authentication by using a mobile number bound to the Huawei account. The mobile phone displays prompt information 71 on the interface 701. The mobile phone detects an operation of tapping an allow control 72 by the user, and determines that the user indicates to complete authorization and authentication by using the mobile number bound to the Huawei account.

It may be understood that, during account registration, the mobile phone may bind user information such as a mobile number and an email address to an account, and may further determine a mobile number login mode and an email address login mode as secure login modes. In this case, in a scenario shown in FIG. 7, the user may alternatively confirm the login account by logging in to an email address.

In some embodiments, after confirming that authorization on the login account succeeds, the mobile phone may send an unlocking indication to the smart door lock. Correspondingly, after receiving the unlocking indication, the smart door lock may determine that the unlocking indication is sent by an electronic device whose login account is authorized. In this case, the smart door lock may determine to retract the bolt and confirm to perform unlocking.

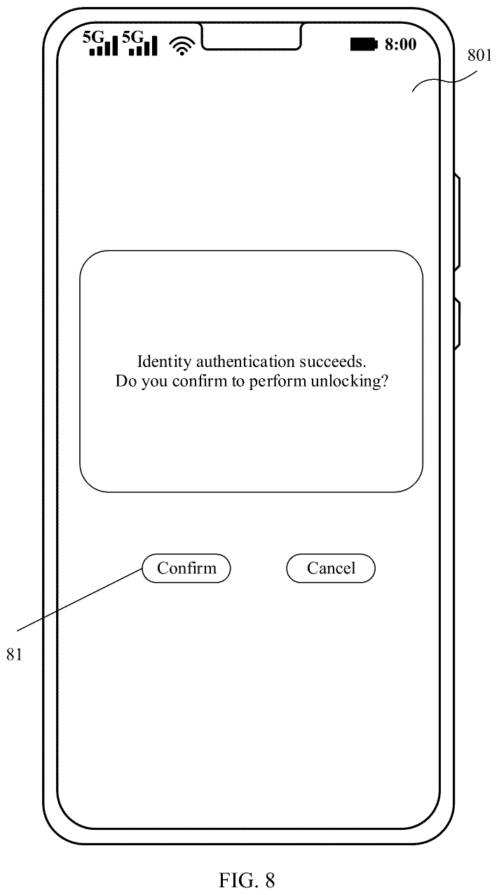

For example, on an interface 801 shown in FIG. 8, if the mobile phone confirms that identity authentication on the user succeeds and login authorization on the account is completed, prompt information may be displayed to prompt the user to confirm whether to indicate the smart door lock to perform unlocking. After detecting an operation of tapping an unlocking confirmation control 81 by the user, the mobile phone may send the unlocking indication to the smart door lock. Correspondingly, the smart door lock completes unlocking based on the received unlocking indication.

Alternatively, after determining that login authorization on the second electronic device (for example, a mobile phone) connected to the smart door lock succeeds, the smart door lock may directly perform unlocking.

In this way, when there is a risk in the environment in which the smart door lock is closed, a stranger may also complete unlocking on the smart door lock after completing authorization on the account login by using an electronic device carried by the stranger. This avoids a danger or a property loss caused when the owner of the smart door lock (for example, a user who knows a password of the smart door lock or a user whose fingerprint template is stored in the smart door lock) is not nearby.

In addition, the second electronic device whose login account is authorized is allowed to indicate the smart door lock to perform unlocking, so as to avoid, to some extent, a hazard that is caused to an article in the environment in which the smart door lock is closed, and that is caused when any second electronic device indicates the smart door lock to perform unlocking.

The foregoing describes how the smart door lock determines the security level and a processing manner corresponding to the determined security level. In some embodiments, after obtaining one or more of the environment monitoring data, the user monitoring data, and the user data, the smart door lock may determine that there is a risk in the current environment in which the smart door lock is closed. In this case, the smart door lock may determine to allow performing unlocking by authorizing the login account, or directly confirm to perform unlocking. In other words, the smart door lock may not need to first determine the security level and then determine the processing manner. Instead, after determining that there is a risk, the smart door lock directly determines to execute a preset execution manner. This can improve unlocking efficiency and reduce the risk.

In some embodiments, during authorization on the login account, a face image of the user may be further collected, so that the owner of the smart door lock subsequently confirms an identity of a user who performs unlocking. This further ensures security of an article in the environment in which the smart door lock is closed.

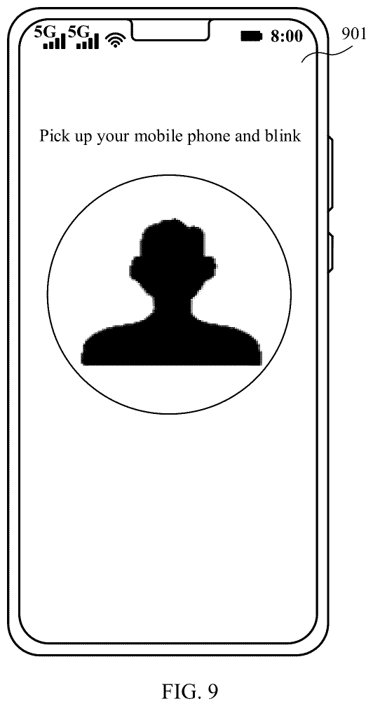

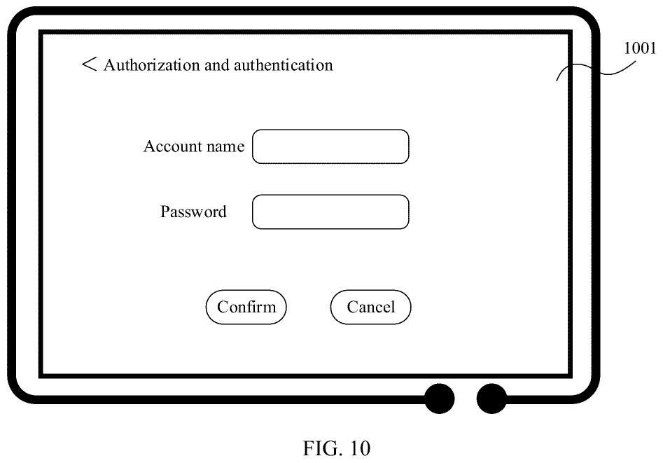

For example, after completing identity authentication on the user on the interface 604 shown in FIG. 6(d), the mobile phone may display an interface 901 shown in FIG. 9, and collect the face image of the user. Then, the mobile phone may send the collected face image of the user to a server (for example, the second server). In this case, if the owner of the smart door lock needs to confirm an identity of a user who performs unlocking, the owner of the smart door lock may request the second server to download the face image of the user. Alternatively, the mobile phone directly sends the face image of the user to the smart door lock. In this case, the smart door lock may also send the obtained face image of the user to the second server for backup. Alternatively, after obtaining the face image of the user, the second server directly sends the face image of the user to the smart door lock, for example, determines a corresponding smart door lock based on the obtained ID of the smart door lock. Alternatively, the second server may automatically push the face image of the user to an electronic device (for example, a mobile phone) specified by the owner of the smart door lock. The electronic device specified by the owner of the smart door lock and the smart door lock are bound to a same account. In addition, there may be one or more electronic devices, and the owner may determine, based on a requirement, an electronic device that obtains the face image of the user.

Optionally, during authorization on the login account, the mobile phone may perform liveness detection by collecting the face image (for example, indicating the user to blink, open the mouth, or turn the head), to determine that the user requesting login and a user registered with a real name are a same user. This prevents others from embezzling the account for authorization. In this case, the mobile phone may directly send the face image obtained in the process to the second server, or directly send the face image to the smart door lock, without a need to separately collect the face image of the user after authorization on the login account. This simplifies a user operation.

When establishing a connection to the smart door lock, the mobile phone may obtain information about the second server. In this case, the mobile phone may send the face image of the user to the second server based on the information about the second server. Optionally, during authorization on the login account, the mobile phone may alternatively send the obtained face image of the user to the first server. The first server sends the face image of the user to the second server based on the obtained information of the second server that is sent by the mobile phone.

In some embodiments, the smart door lock may alternatively collect, by using a camera of the smart door lock, an image of the user who performs unlocking. For example, after the smart door lock determines to perform unlocking in a trust-based login account authorization manner, the smart door lock may start the camera to shoot a photo or record a video of the user who performs unlocking. This ensures safety of an article in the environment in which the smart door lock is closed.

In some embodiments, the second server or the smart door lock may further store identity information of the user who performs unlocking, for example, input account information and real-name authentication information. The identity information can be viewed under a preset condition. After completing authentication on the login account, the first server may send the identity information of the user who performs unlocking to the second server.

For example, an unauthorized person like a thief performs unlocking by authorizing the login account, and the second server and the smart door lock may store identity information of a user corresponding to an account. In this case, after determining a property loss in the environment in which the smart door lock is closed, the owner may report an alarm, and a related worker (for example, a police officer) with permission may view the identity information, of the user who performs unlocking, stored in the smart door lock, or indicate the smart door lock to obtain the identity information, of the user who performs unlocking, stored in the second server, to quickly trace the user who performs unlocking. This avoids a loss of the owner, and can deter an unauthorized person who wants to illegally enter and steal property.

In some embodiments, when determining the security level as a mode (for example, the dangerous mode or the emergency mode) other than the abnormal mode, the smart door lock may play an alarm audio by using the audio module 250 shown in FIG. 2, and/or flash an indicator light by using the indicator 261, to attract attention of a surrounding person and avoid a risk that has a bigger danger and that occurs because no one notices a danger in the current environment in which the smart door lock is closed.

In some embodiments, after determining the security level, the smart door lock further continuously performs environment monitoring. In this case, if determining that the risk is reduced or eliminated, the smart door lock may perform a corresponding processing manner.

For example, as described in Example 1 shown in FIG. 4 and Table 1, the smart door lock determines, based on the current ambient temperature, that the temperature is greater than the threshold 2 (for example, 70° C.) and the condition 2 is met. In this case, when determining the current security level as the emergency mode, the smart door lock may directly indicate to retract the bolt, to implement unlocking. Then, if the smart door lock determines, based on the received environment monitoring data, that the ambient temperature decreases to be less than 70° C. but greater than 50° C. (for example, the threshold 1 is 50° C.), the condition 1 is met. Then, as shown in Table 1, the smart door lock may re-determine the current security level as the dangerous mode. In view of this, the smart door lock may indicate to release the bolt to confirm that the door lock is closed. However, the second electronic device is allowed to perform unlocking by authorizing the login account.

Subsequently, if the smart door lock determines, based on the environment monitoring data, that the temperature is less than or equal to the threshold 1, as shown in Table 1, the smart door lock may re-determine the security level as the normal mode. It may be determined that the danger is eliminated, and the second electronic device is no longer allowed to perform unlocking by authorizing the login account.

In this way, the smart door lock can adaptively determine, based on the environment monitoring data, whether to allow unlocking indicated by a person who is not the owner of the smart door lock. This can flexibly reduce a risk and ensure property security of the owner of the smart door lock.

In some embodiments, after the smart door lock determines to perform unlocking in an authorization manner in which the second electronic device logs in to an account or to directly and automatically perform unlocking, the smart door lock may send prompt information to an electronic device of an owner of a corresponding smart door lock, to notify the owner that the smart door lock has been opened. This ensures that the owner can timely confirm a situation in the environment in which the smart door lock is closed.

For example, the smart door lock is already bound to a mobile phone of the owner of the smart door lock. In this case, after the smart door lock determines to perform unlocking in the authorization manner in which the second electronic device logs in to the account or to directly and automatically perform unlocking, the smart door lock may send the prompt information to the mobile phone of the owner. For example, the prompt information is “At 10:00 a.m., the room is in a dangerous mode, someone has opened the smart door lock after security authorization.” For another example, the prompt information is “At 2:00 p.m., the vehicle is in an emergency mode, and the smart car door lock has been automatically opened”.

In some embodiments, when determining the security level as a mode (for example, the dangerous mode or the emergency mode) other than the abnormal mode, the smart door lock may also send risk warning information to an electronic device (for example, the mobile phone of the owner) associated with the owner of the smart door lock, to remind the owner that there is a security risk in the current environment in which the smart door lock is closed. Correspondingly, the owner can remotely perform unlocking based on the risk warning information to further avoid occurrence of the danger.

In some embodiments, if the smart door lock has a security authorization capability, the smart door lock may directly perform security authorization based on the capability, without a need to confirm, by using the second electronic device (for example, a mobile phone), an identity of a user who needs to open the door lock.

For example, the smart door lock determines the security level as the dangerous mode or the emergency mode, and determines that there is a risk, the smart door lock allows the user to perform unlocking by authorizing the login account. In this case, if an operation of tapping an unlocking button or an unlocking control on the smart door lock by the user (not the owner) is detected, an authorization and authentication interface 1001 shown in FIG. 10 may be displayed. On the interface, the user may log in to a real name authentication account, for example, a Huawei account, so that authorization on the login account is directly completed on the smart door lock. For example, the smart door lock sends the obtained account name and password to the second server. After determining that the account password is correct, the second server may indicate the smart door lock to retract the bolt and open the door lock.

This ensures that the smart door lock can also be opened by a nearby person who does not carry an electronic device, to further reduce damage caused by a possible risk to the environment in which the smart door lock is closed.

In some embodiments, the first electronic device may alternatively be an electronic device like a mobile phone. In this case, in the foregoing embodiment, locking of the smart door lock may be understood as a screen-locked state, and unlocking may be understood as unlocking a startup system. In this case, the mobile phone is used as an example. The mobile phone may also determine the security level based on one or more of environment data monitored by a sensor of the mobile phone, user body data monitored by the sensor of the mobile phone, received user monitoring data sent by the wearable device, and the like. If the mobile phone determines the security level as the dangerous mode or the emergency mode, a stranger may also be allowed to perform security authorization by using another electronic device or itself. After determining that authorization succeeds, the mobile phone may perform unlocking.

Optionally, after unlocking, a user who performs unlocking in a security authorization manner is allowed to read limited information, for example, only information in a phone book, to ensure device information security of the first electronic device.

In this way, when the owner of the first electronic device is in danger, a nearby person may determine telephone information of the owner in the security authorization manner, and may contact a person related to the owner, for example, a family member of the owner. This avoids a situation where related rescue measures cannot be taken because the owner lacks of awareness, an identity of the owner cannot be obtained, and a related person cannot be contacted.

For example, FIG. 11A-1 and FIG. 11A-2 are a schematic flowchart 1 of an unlocking method according to an embodiment of this application. As shown in FIG. 11A-1 and FIG. 11A-2, the method includes the following steps.

S1101: A first electronic device obtains first data.

In some embodiments, the first electronic device may obtain the first data sent by one or more of a sensor in an environment in which the first electronic device is located, a sensor of the first electronic device, a third electronic device that is provided with a sensor and that is in an environment in which the first electronic device is located, and a central control device in an environment in which the first electronic device is located. The first data may include one or more of environment monitoring data, user monitoring data, user data, and security level data.

The environment in which the first electronic device is located includes an environment in which the first electronic device is closed, for example, an environment in a room provided with a smart room door lock, or an environment in a vehicle provided with a smart car door lock.

The sensor included in the first electronic device includes, for example, the temperature sensor shown in FIG. 2. The sensor in the environment in which the first electronic device is located includes, for example, a temperature sensor, a smoke sensor, and a water immersion sensor. The third electronic device includes, for example, a camera and a wearable device. The central control device includes, for example, a smart home control panel and a vehicle central control panel.

The environment monitoring data includes, for example, a temperature, smoke concentration, and a water immersion situation. The user monitoring data includes, for example, a heart rate, blood pressure, and a blood oxygen level. The user data includes, for example, disease data. The user is a user associated with the first electronic device. The security level data includes, for example, the security level described in the foregoing embodiment, for example, the security mode, the dangerous mode, and the emergency mode.

S1102: The first electronic device determines, based on the first data, that there is a first risk in the environment in which the first electronic device is located.

In some embodiments, the first risk includes one or more of the following: a fire risk, a flood risk, an individual activity risk of a child, and a risk of disease in the elderly.

In some embodiments, after obtaining the first data, the first electronic device may determine whether there is a risk of danger in a current environment.

For example, in the example 1 shown in Table 1, when the first electronic device determines, based on the first data, that the current temperature is greater than the threshold 1, the first electronic device may determine that there is the first risk in the environment in which the first electronic device is located, and determine the security level as the dangerous mode. Alternatively, when the first electronic device determines that the temperature is greater than the threshold 2, the first electronic device may determine that there is the first risk in the environment in which the first electronic device is located, and determine the security level as the emergency mode.

For another example, the central control device may directly determine the security level of the environment in which the first electronic device is located, and then may send the security level data to the first electronic device. In this case, the first electronic device may directly determine the security level based on the obtained security level data, without a need to perform security level division. After obtaining the security level data, the first electronic device may determine that there is the first risk in the environment in which the first electronic device is located.

S1103: A second electronic device sends a connection request to the first electronic device.

S1104: The first electronic device establishes a connection to the second electronic device.

In some embodiments, in step S1103 and step S1104, after determining that there is the first risk in the environment in which the first electronic device is located, the first electronic device may allow access of another electronic device, so that the another electronic device performs unlocking by authorizing a login account.

For example, after determining that there is the first risk in the environment in which the first electronic device is located, the first electronic device may start security authorization-based unlocking, and allow access of the second electronic device by using a proximity detection function. For example, when the user touches an NFC sensing area of a smart door lock (namely, the first electronic device) by using a mobile phone (namely, the second electronic device), the mobile phone may establish a communication connection to the smart door lock.

S1105: The second electronic device displays a first interface, and obtains login account information in response to a first operation performed on the first interface.

In some embodiments, after determining that the second electronic device has established a connection to the first electronic device, the second electronic device may start to authenticate a user identity, for example, authenticate the user identity by authorizing the login account, to avoid a loss caused by any second electronic device operating the first electronic device. The second electronic device may display an authorization and authentication interface, and receive login account information input by the user. Alternatively, the second electronic device may obtain login account information locally stored in the second electronic device without requiring the user to input the login account information.

For example, on the interface 603 shown in FIG. 6(c), the second electronic device displays the authorization and authentication interface, and the user may choose, based on a registered account of the user, to perform authorization and authentication by using a Huawei account, an application A (for example, WeChat®), or an application B (for example, Alipay®). If the second electronic device detects an operation performed on the control 63, and determines that the user indicates to perform authorization and authentication by using the Huawei account, the interface 604 shown in FIG. 6(d) may be displayed. On the interface 604, the second electronic device may receive an account name and a password that are input by the user. After detecting an operation of tapping the confirm control 64 by the user, the second electronic device determines that the user completes a login operation on the Huawei account.

Alternatively, when the interface 603 shown in FIG. 6(c) is displayed, the second electronic device detects an operation of tapping the control 63 by the user, and confirms that the user indicates to complete authorization and authentication by using the Huawei account. In addition, the second electronic device confirms that the second electronic device has logged in to the Huawei account (that is, the second electronic device locally stores login account information of the Huawei account). In this case, the second electronic device may display the interface 701 shown in FIG. 7, and complete authorization and authentication by using a mobile number bound to the Huawei account. The second electronic device displays the prompt information 71 on the interface 701. The second electronic device detects an operation of tapping the allow control 72 by the user, and determines that the user indicates to complete authorization and authentication by using the mobile number bound to the Huawei account.

S1106: The second electronic device sends the login account information to the first server.

In some embodiments, after obtaining the login account information, the second electronic device may send the login account information to a corresponding server (for example, the first server), to perform authorization and authentication on the login account information. Correspondingly, the first server receives the login account information sent by the second electronic device.

Optionally, the first server is, for example, a Huawei server or a third-party application server.

S1107: The first server determines, based on the login account information, whether to perform authorization.

That a login account of the second electronic device is authorized includes: Real-name identity information of the user is bound to the login account of the second electronic device. The real-name identity document information of the user includes, for example, identity information (for example, a name, an ID number, and a place of residence), face information, and a real name of the user.

In some embodiments, after obtaining the login account information, the first server determines an unlocking authorization status, for example, whether real-name authentication on a corresponding login account succeeds, or whether an account password is correct.

For example, if the first server determines that the obtained password is the same as a preset password corresponding to an account name of the login account, the first server may consider that the account password is correct, and may determine that authentication succeeds. After determining that authentication on the login account succeeds, the first server may determine unlocking authorization.

For another example, if the first server determines, based on the login account information, that the obtained password is different from a preset password corresponding to an account name of the login account, the first server considers that the account password is incorrect, and may determine that authentication on the login account fails. After determining that authentication on the login account fails, the first server determines that unlocking authorization fails, and may send, to the second electronic device, a signal indicating an unlocking authorization failure. Further, the second electronic device may collect login account information input by the user, and send the information to the first server to determine the newly obtained login account information, so as to avoid an unlocking authorization failure caused by an input error.

S1108a: After determining to perform unlocking authorization, the first server sends a fourth signal to the second electronic device.

In some embodiments, after determining the unlocking authorization status, the first server may determine corresponding authorization confirmation information, for example, a key or check code, and generate the fourth signal that carries the authorization confirmation information. The authorization confirmation information is information determined by the first server according to a preconfigured rule corresponding to security authorization-based unlocking. It should be understood that the first electronic device is also pre-provided with a rule corresponding to security authorization-based unlocking, so that the first electronic device can identify the authorization confirmation information, and subsequently the first electronic device may determine an authorization status of the second electronic device based on the authorization confirmation information.

Then, the first server sends the fourth signal to the second electronic device. Correspondingly, the second electronic device receives the fourth signal sent by the first server.

S1109: The second electronic device obtains, based on the fourth signal, unlocking authorization that allows controlling the first electronic device to perform unlocking.

In some embodiments, after obtaining the fourth signal, the second electronic device may determine, based on the fourth signal, to obtain unlocking authorization from the first electronic device.

For example, the fourth signal is sent in a form of a packet, and a packet header of the packet includes a flag bit indicating the unlocking authorization status. The second electronic device determines, based on a value of the flag bit, whether unlocking authorization on the first electronic device is obtained. If the value of the flag bit is 1, it indicates that unlocking authorization that allows controlling the first electronic device to perform unlocking is obtained. If the value of the flag bit is 0, it indicates that unlocking authorization that allows controlling the first electronic device to perform unlocking is not obtained.

For another example, a signal transmission rule is preset in the second electronic device and the first server, and a transmitted signal carries an identifier indicating the unlocking authorization status. For example, the second electronic device may determine, based on a first identifier of the fourth signal, that unlocking authorization that allows controlling the first electronic device to perform unlocking is obtained. Alternatively, when determining, based on the login account information sent by the second electronic device, an unlocking authorization failure of the second electronic device, the first server may send a fifth signal to the second electronic device, and the second electronic device determines, based on a second identifier of the fifth signal, that unlocking authorization that allows controlling the first electronic device to perform unlocking is not obtained. The second identifier is different from the first identifier.

It should be noted that an implementation of the fourth signal is merely an example for description, and the second electronic device may alternatively determine an unlocking authorization status of the login account according to another preset rule corresponding to security authorization-based unlocking.

S1110: The second electronic device sends a first signal to the first electronic device.

In some embodiments, after determining that the login account is authorized, the second electronic device may generate the first signal that carries the authorization confirmation information.

Then, the second electronic device sends the first signal to the first electronic device. Correspondingly, the first electronic device receives the first signal sent by the second electronic device.

In some embodiments, after determining that unlocking authorization that allows controlling the first electronic device to perform unlocking is obtained, the second electronic device may display an authorization prompt interface, to prompt the user that the second electronic device has obtained unlocking authorization from the first electronic device.

S1111: The first electronic device determines, based on the first signal, that the login account of the second electronic device is authorized.

In some embodiments, the first electronic device may obtain the authorization confirmation information carried in the first signal, parse the authorization confirmation information according to a preset rule, and further determine the authorization status of the login account of the second electronic device. For example, the first electronic device obtains a key or check code carried in the first signal, parses the key or the check code according to the preconfigured rule corresponding to security authorization-based unlocking, and further determines that the login account of the second electronic device is authorized.

S1112: When there is the first risk in the environment in which the first electronic device is located, and it is determined that the login account of the second electronic device is authorized, confirm to perform unlocking.

In some embodiments, the first electronic device determines that there is the first risk in the environment in which the first electronic device is located in the step S1102, and determines, based on the obtained first signal, that the login account of the second electronic device connected to the first electronic device is authorized in step S1111. In this case, the first electronic device may determine to perform unlocking.

In some embodiments, after retracting a bolt to perform unlocking, the first electronic device may further send a signal to the second electronic device, where the signal indicates that the first electronic device is unlocked. Correspondingly, after receiving the signal, the second electronic device may notify, through a voice or interface display, the user that the first electronic device is unlocked, so that the user can timely confirm an unlocking situation.

In this way, when there is a risk in the environment in which the first electronic device is closed, a stranger may also complete unlocking on the first electronic device after completing account login authorization by using a second electronic device carried by the stranger. This avoids a danger or a property loss caused when the risk occurs and an owner of the first electronic device does not appear nearby.

In addition, the second electronic device whose login account is authorized is allowed to indicate the first electronic device to perform unlocking, so as to avoid, to some extent, a hazard that is caused to an article in the environment in which the first electronic device is closed, and that is caused when any second electronic device indicates the first electronic device to perform unlocking.

In some embodiments, the first electronic device may determine the authorization status of the login account of the second electronic device in a plurality of implementations. For example, in an implementation (1), as described in the step S1108a to the step S1111, the first electronic device may determine the authorization status of the login account of the second electronic device based on the obtained first signal sent by the second electronic device. For another example, in an implementation (2), after determining unlocking authorization status of the second electronic device, the first server may send, to the second server for managing the first electronic device, the second signal that carries the unlocking authorization status, and the second server forwards the second signal to the first electronic device. Then, the first electronic device determines the unlocking authorization status of the second electronic device based on the second signal. For another example, in an implementation (3), with reference to the implementation (1) and the implementation (2), the first electronic device determines the authorization status of the login account of the second electronic device based on the first signal and the second signal.

The following describes the implementation (2) and the implementation (3) of the implementations in which the first electronic device determines the authorization status of the login account of the second electronic device. It should be noted that, for specific descriptions of the implementation 1, refer to the step S1108a to the step S1111. Details are not described herein again.

### Implementation (2)

In this implementation, as shown in FIG. 11B-1 and FIG. 11B-2, after determining that authentication on the login account of the second electronic device succeeds and unlocking authorization succeeds (that is, after step S1107), the first server may send the second signal to the second server for managing the first electronic device. Then, the first electronic device completes determining of the authorization status of the login account of the second electronic device based on the obtained second signal forwarded by the second server. In the implementation 2, the step S1108b to the step S1114 are included.

S1108b: After determining to perform unlocking authorization, the first server sends the second signal to the second server.

In some embodiments, in the step S1104, when establishing a connection to the first electronic device, the second electronic device may obtain a device ID of the first electronic device and a communication address of a second server for managing a smart door lock. Therefore, in the step S1106, the login account information sent by the second electronic device to the first server may carry the device ID of the first electronic device and the communication address of the second server for managing the smart door lock. Correspondingly, the first server may obtain the device ID of the first electronic device and the communication address of the second server for managing the smart door lock. In this case, after determining to perform unlocking authorization, the first server may determine the second server based on the communication address of the second server, and then send the second signal to the second server. The second signal indicates the unlocking authorization status of the login account of the second electronic device. If the first server may obtain a device ID of the second electronic device during communicating with the second electronic device, the second signal may carry the device ID of the first electronic device and the device ID of the second electronic device.

S1113: The second server forwards the second signal to the first electronic device.

In some embodiments, after receiving the second signal, the second server may determine the corresponding first electronic device based on the device ID that is of the first electronic device and that is carried in the second signal. Then, the second server forwards the obtained second signal to the first electronic device, and includes the device ID of the second electronic device in the forwarded second signal. Alternatively, the second server may generate, based on the second signal, a new signal indicating the unlocking authorization status of the login account of the second electronic device, and send the signal to the first electronic device.

S1114: The first electronic device determines, based on the second signal, that the login account of the second electronic device is authorized.

In some embodiments, the first electronic device may receive the second signal sent by the second server. Then, the first electronic device may obtain, based on the second signal, the device ID of the second electronic device carried in the second signal, and further determine the authorization status of the corresponding login account of the second electronic device, for example, determine that the login account of the second electronic device is authorized.

For example, the second signal is sent in a form of a packet, and a packet header of the packet includes a flag bit indicating the unlocking authorization status. The first electronic device determines, based on a value of the flag bit, whether unlocking authorization on the login account of the second electronic device is obtained. If the value of the flag bit is 1, it indicates that unlocking authorization on the login account of the second electronic device is obtained. If the value of the flag bit is 0, it indicates that unlocking authorization on the login account of the second electronic device is not obtained.

For another example, a signal transmission rule is preset in the first electronic device and the second server, and a transmitted signal carries an identifier indicating the unlocking authorization status. For example, the first electronic device may determine, based on a third identifier of the second signal, that unlocking authorization on the login account of the second electronic device is obtained. Alternatively, the first electronic device determines, based on a fourth identifier of the obtained signal, that unlocking authorization on the login account of the second electronic device is not obtained. The third identifier is different from the fourth identifier.

It should be noted that an implementation of the second signal is merely an example for description, and the first electronic device may alternatively determine the unlocking authorization status of the login account of the second electronic device according to another preset rule corresponding to security authorization-based unlocking.

### Implementation (3)

As shown in FIG. 11B-1 and FIG. 11B-2, with reference to the implementation 1 and the implementation 2, after determining that authentication on the login account of the second electronic device succeeds and unlocking authorization succeeds (that is, after step S1107), the first server may send an authorization signal to the second electronic device and transmits the authorization signal to the second server. In this case, the first electronic device may determine, with reference to the authorization signal (for example, the first signal) forwarded by the second electronic device and the authorization signal (for example, the second signal) forwarded by the second server, that the second electronic device obtains unlocking authorization. This avoids an unlocking authorization failure caused by a signal sending failure. It should be noted that, for specific descriptions in the implementation (3), refer to related descriptions in the implementation (1) and the implementation (2). Details are not described herein again.

In some embodiments, after determining, based on the first data, that there is the first risk in the environment in which the first electronic device is located, the first electronic device may further play an alarm audio by using an audio module, and/or flash an indicator light.

In this way, after determining the first risk, the first electronic device may attract attention of a surrounding person in the foregoing manner, to avoid a risk that has a bigger danger and that occurs because no one notices a risk in a current environment in which the first electronic device is closed.

In some embodiments, after determining the first risk or confirming to perform unlocking, the first electronic device may further continue to monitor the environment in which the first electronic device is located, to obtain corresponding second data, where the second data includes the first data. Then, whether there is still the first risk in the environment in which the first electronic device is located may be determined based on the second data. For example, after determining, based on the second data, that there is no first risk in the environment in which the first electronic device is located, the first electronic device determines to close the lock.

In this way, the first electronic device can adaptively determine, based on the environment monitoring data, whether to allow performing unlocking as indicated by an owner of an electronic device other than the first electronic device. This can flexibly reduce a risk and ensure property security of an owner of the smart door lock.

In some scenarios, to further ensure security of the environment in which the first electronic device is closed, a face image of a user who performs unlocking by using the second electronic device may be further collected, so that an identity of the user who performs unlocking can be more accurately determined. This facilitates the owner of the first electronic device to subsequently trace the identity of the user who performs unlocking.

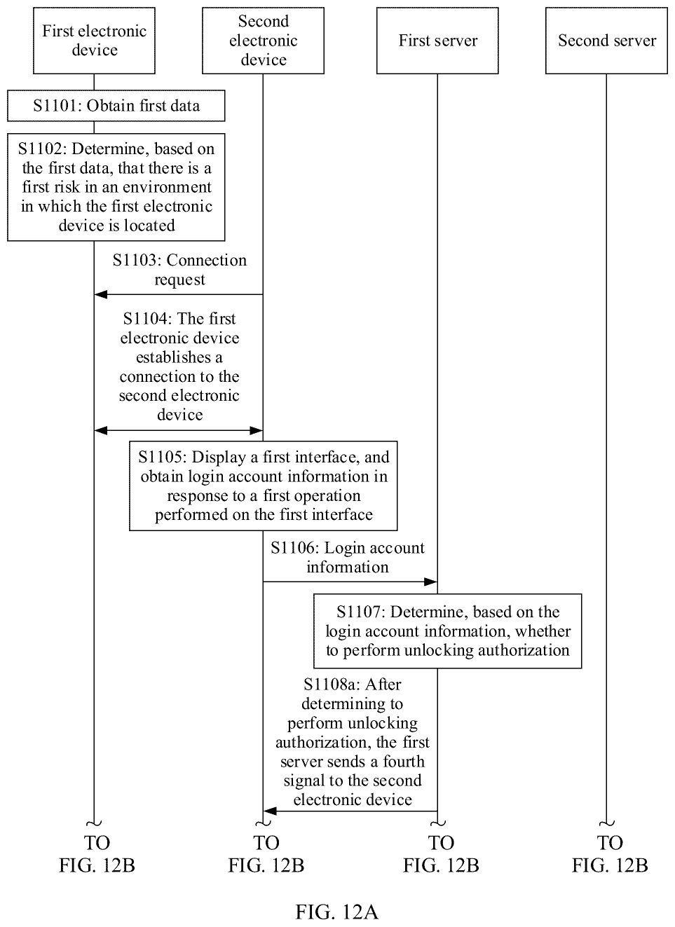

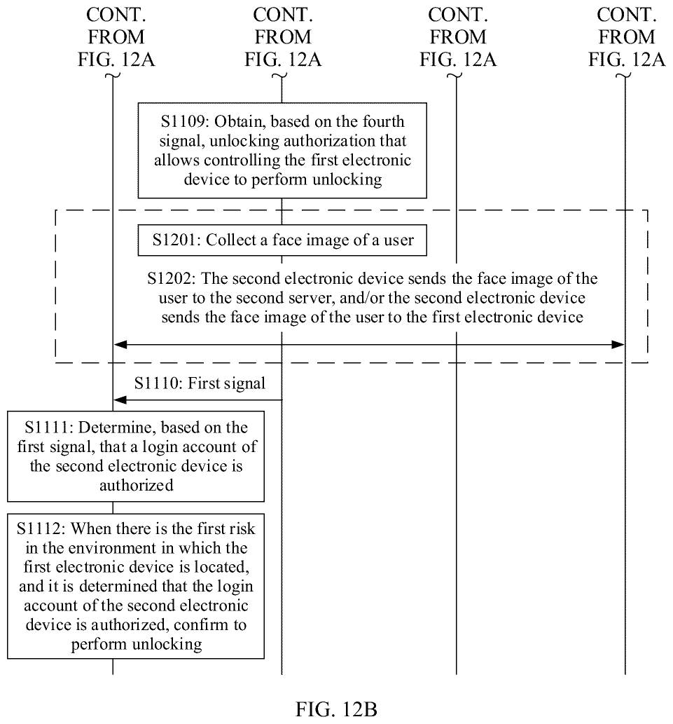

Optionally, based on a schematic flowchart of the unlocking method shown as FIG. 11A-1 and FIG. 11A-2, FIG. 12A and FIG. 12B are a schematic flowchart of still another unlocking method according to an embodiment of this application. As shown in FIG. 12A and FIG. 12B, before confirming to perform unlocking, the first electronic device may further obtain the face image of the user who indicates, by using the second electronic device, to perform unlocking (that is, the step S1201 and the step S1202 may be performed).

It may be understood that, in the implementation 2 shown in FIG. 11B-1 and FIG. 11B-2, before confirming to perform unlocking, the first electronic device may further obtain the face image of the user who indicates, by using the second electronic device, to perform unlocking (that is, the step S1201 and the step S1202 may be performed). Alternatively, in the implementation (3) in which before confirming to perform unlocking, the first electronic device determines, based on the first signal and the second signal, the authorization status of the login account of the second electronic device, the first electronic device may obtain the face image of the user who indicates, by using the second electronic device, to perform unlocking (that is, the step S1201 and the step S1202 may be performed). Details are not described herein again.

For example, as shown in FIG. 12A and FIG. 12B, after step S1109 and before step S1110, that is, after the second electronic device determines that unlocking authorization is completed and before the second electronic device sends the first signal to the first electronic device, the second electronic device may perform step S1201 and step S1202. It should be noted that, in the implementation (2), the second electronic device may perform S1201 and step S1202 after performing step S1105.

S1201: The second electronic device collects a face image of a user.

In some embodiments, during authorization on the login account, the second electronic device may further collect the face image of the user, so that the owner of the first electronic device subsequently confirms an identity of the user who performs unlocking. This further ensures security of an article in the environment in which the first electronic device is closed.

For example, on the interface 901 shown in FIG. 9, the second electronic device may display a face image collection interface during or after authorization on the login account, to collect the face image of the user.

S1202: The second electronic device sends the face image of the user to the second server, and/or the second electronic device sends the face image of the user to the first electronic device.

In some embodiments, after collecting the face image of the user, the second electronic device may send the collected face image of the user to the second server and/or the first electronic device. The second server is a server corresponding to the first electronic device, for example, a smart home server, and may be configured to manage the first electronic device.

For example, if the second electronic device has a smart home service function (for example, a smart home application is installed), and the user has registered an account of the smart home application, the second electronic device can establish a connection to a smart home server (the second server), and can send the obtained face image of the user to the smart home server. The smart home server is also a server corresponding to the first electronic device, namely, a server for managing the first electronic device. Subsequently, the first electronic device or another electronic device of the owner of the first electronic device may request the smart home server to download the face image of the user, or the smart home server may directly send the face image of the user to the first electronic device or another electronic device of the owner of the first electronic device. Therefore, the owner of the first electronic device can determine, based on the obtained face image of the user, a user who indicates to perform unlocking.

For another example, after obtaining the face image of the user, the second electronic device may directly send the face image of the user to the first electronic device (for example, when the second electronic device does not have a smart home service function). Optionally, after obtaining the face image of the user, the first electronic device may further upload the face image of the user to the second server for backup. Similarly, the owner of the first electronic device can determine, based on the obtained face image of the user, a user who indicates to perform unlocking.

In this way, the face image of the user who indicates to perform unlocking is collected, so that traceability is further increased, and security of the environment in which the first electronic device is closed is ensured.

It should be noted that, in the scenario shown in FIG. 12A and FIG. 12B, after completing authentication on the login account of the second electronic device (that is, step S1107), the first server may send login information of the login account to the second server. For example, the first server obtains the communication address of the second server from the received authentication request sent by the second electronic device, determines the second server based on the communication address of the second server, and sends the login information of the login account to the second server. Alternatively, after determining that authentication succeeds (that is, step S1109), the second electronic device may send the login information to the second server. Subsequently, the second server may send the login information based on a request of an owner of the second electronic device, so that the owner determines the user who performs unlocking.

In some scenarios, after determining that authorization on the login account succeeds, the second electronic device may determine, based on the user indication, whether to indicate the first electronic device to perform unlocking, so as to implement more flexible unlocking.

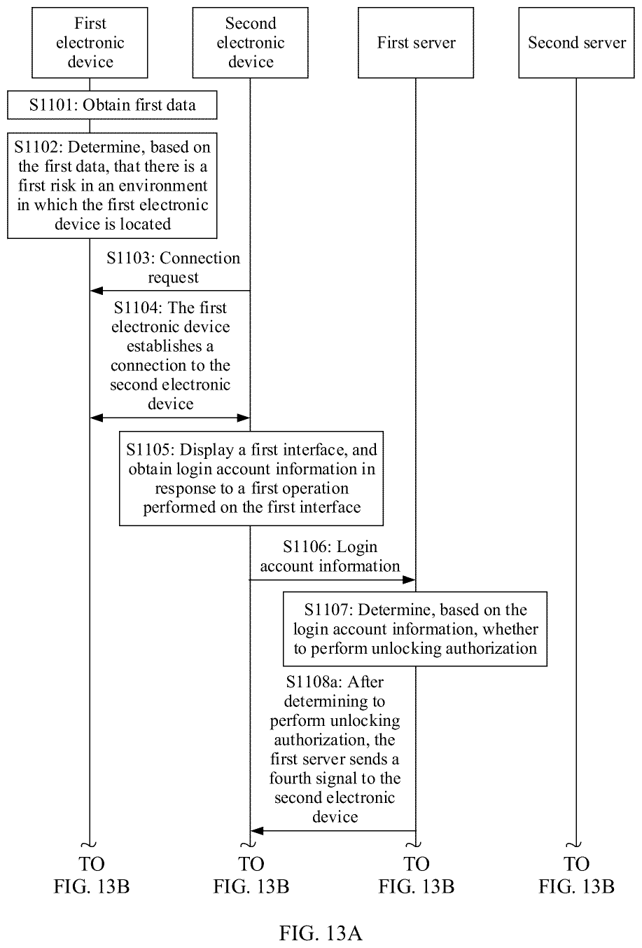

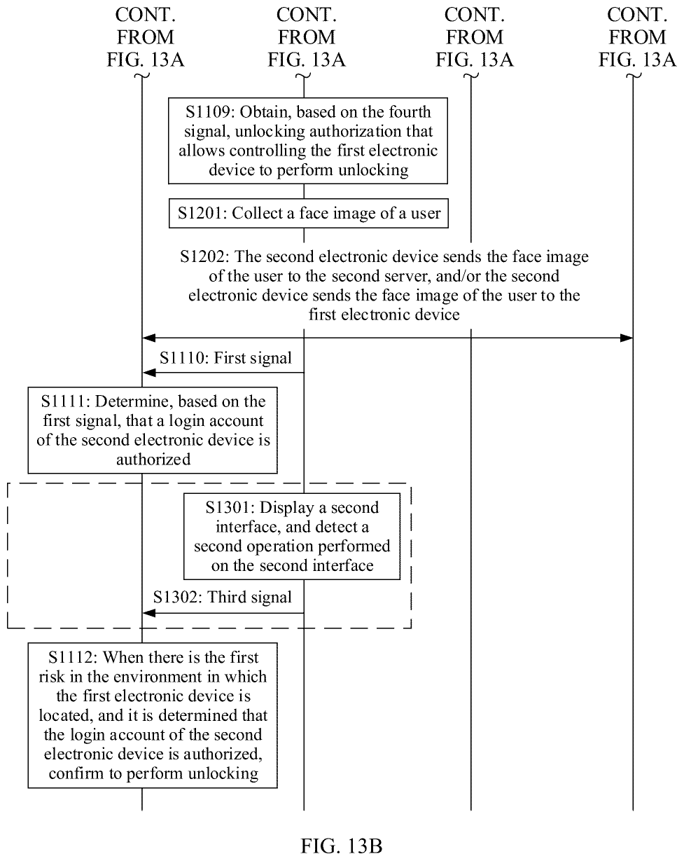

Optionally, based on the schematic flowchart of the unlocking method shown as FIG. 12A and FIG. 12B, FIG. 13A and FIG. 13B are a schematic flowchart of still another unlocking method according to an embodiment of this application. As shown in FIG. 13A and FIG. 13B, the method may further include step S1301 and step S1302 after step S1111.

S1301: The second electronic device displays a second interface, and detects a second operation performed on the second interface.

S1302: The second electronic device sends a third signal to the first electronic device.

In some embodiments, in step S1301 and step S1302, after determining that authorization on the login account succeeds, the second electronic device may display an unlocking confirmation interface. Then, the second electronic device determines, based on a second operation performed by the user on the interface, whether to indicate the first electronic device to perform unlocking. If the second electronic device determines to indicate the first electronic device to perform unlocking, the second electronic device may send, to the first electronic device, a third signal indicating to perform unlocking.

For example, on the interface 801 shown in FIG. 8, the second electronic device displays prompt information, to prompt the user to confirm whether to indicate the first electronic device to perform unlocking. After detecting an operation (namely, the second operation) of tapping the unlocking confirmation control 81 by the user, the second electronic device may send the third signal to the first electronic device.

Correspondingly, the first electronic device may receive the third signal, and in the step S1112, the first electronic device may further confirm, based on the third signal, to perform unlocking.

In this way, the third signal indicating to perform unlocking enhances flexibility of indicating by the user to perform unlocking, and avoids a risk caused through direct unlocking. For example, if a danger like a fire occurs in a room in which a smart door lock is closed and a user who performs unlocking is not well-prepared, direct unlocking may cause a specific loss.

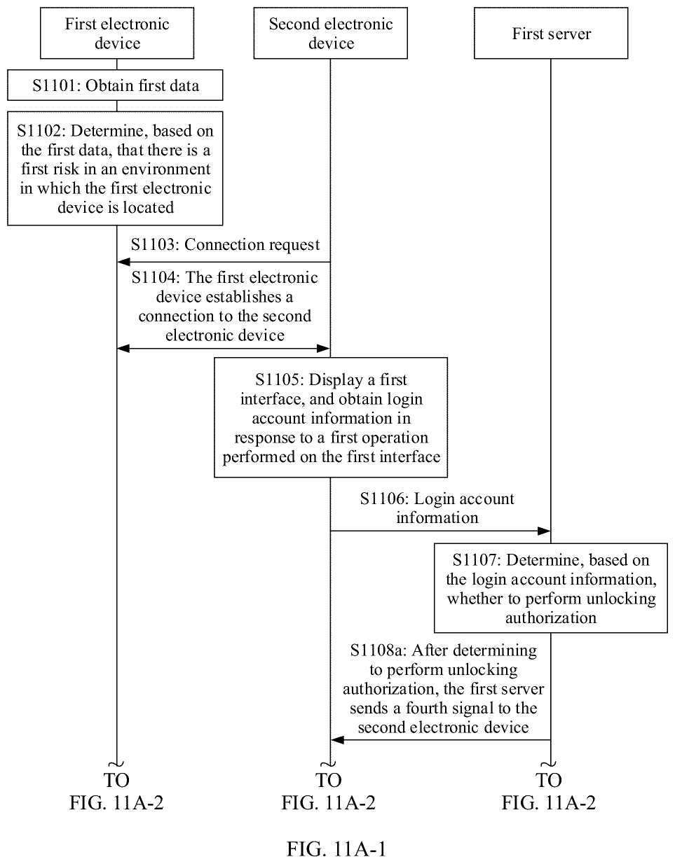

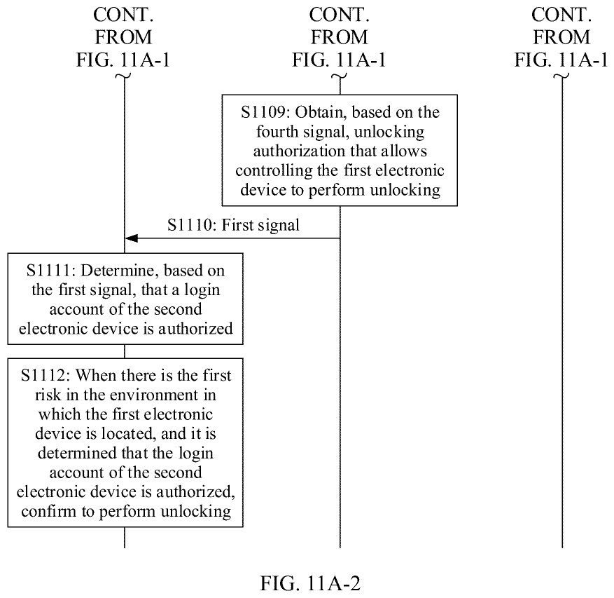

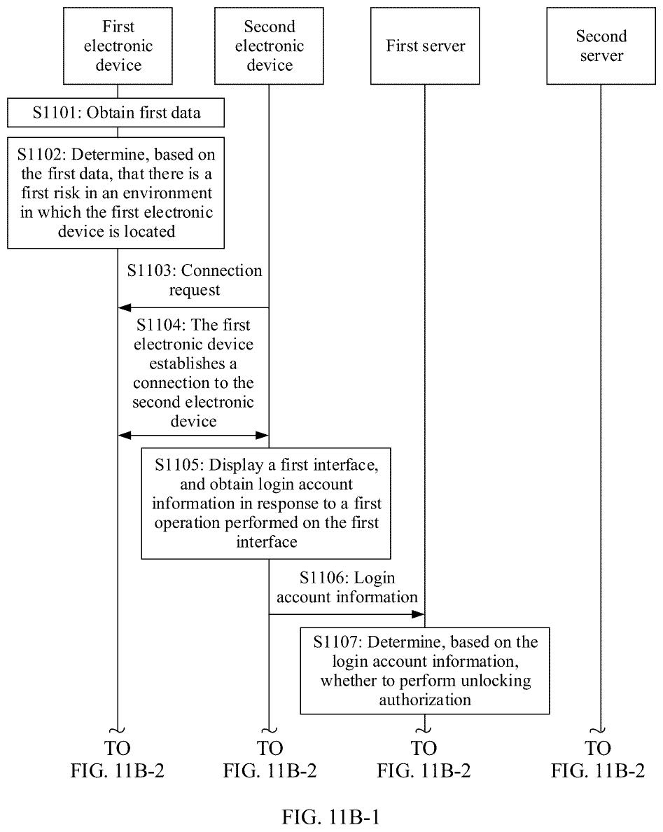

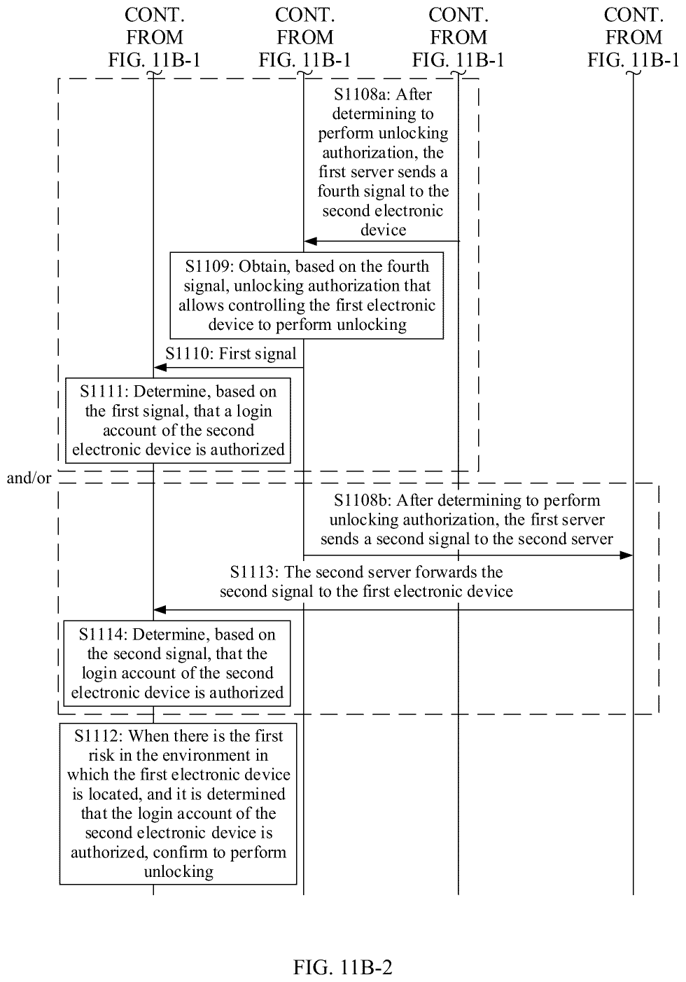

It should be noted that, after the implementation 2 in FIG. 11B-2 (that is, step S1108b to step S1114) that the first electronic device determines the authorization status of the login account of the second electronic device based on the second signal, the first electronic device may alternatively determine, based on the third signal, to perform unlocking. In other words, step S1301 and step S1302 may also be performed after step S1114. Details are not described herein again.

Optionally, in FIG. 11A-1, FIG. 11A-2, FIG. 11B-1, FIG. 11B-2, FIG. 12A, FIG. 12B, FIG. 13A, and FIG. 13B, the first electronic device may further perform steps and functions performed by the smart door lock in the foregoing embodiments, and the second electronic device may further perform steps and functions performed by the mobile phone in the foregoing embodiments, to implement the unlocking method provided in the foregoing embodiments.

Optionally, the first server and the second server may be different servers, or may be one server or a server cluster that can implement functions of the first server and the second server.

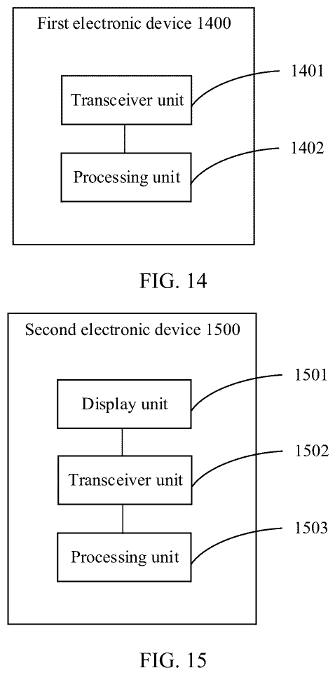

The foregoing describes in detail the unlocking methods provided in embodiments of this application with reference to FIG. 4 to FIG. 13B. With reference to FIG. 14 and FIG. 15, the following describes in detail applications of the first electronic device and the second electronic device to the unlocking methods provided in embodiments of this application.

In a possible design, FIG. 14 is a schematic diagram of a structure of a first electronic device according to an embodiment of this application. As shown in FIG. 14, the first electronic device 1400 may include a transceiver unit 1401 and a processing unit 1402. The first electronic device 1400 may be configured to implement a function of the first electronic device in the method embodiment.

Optionally, the transceiver unit 1401 is configured to: support the first electronic device 1400 in performing S1103, S1104, and S1110 in FIG. 11A-1 and FIG. 11A-2, support the first electronic device 1400 in performing S1113 in FIG. 11B-2, support the first electronic device 1400 in performing S1202 in FIG. 12B, and/or support the first electronic device 1400 in performing S1302 in FIG. 13B.

Optionally, the processing unit 1402 is configured to: support the first electronic device 1400 in performing S1101, S1102, S1111, and S1112 in FIG. 11A-1 and FIG. 11A-2, and/or support the first electronic device 1400 in performing S1114 in FIG. 11B-2.

The transceiver unit may include a receiving unit and a sending unit, may be implemented by a transceiver or a transceiver-related circuit component, and may be the transceiver or a transceiver module. An operation and/or a function of each unit in the first electronic device 1400 is used to implement a corresponding procedure of the unlocking method in the method embodiment. All related content of each step in the method embodiment may be referenced to function descriptions of a corresponding functional unit. For brevity, details are not described herein again.

Optionally, the first electronic device 1400 shown in FIG. 14 may further include a storage unit (not shown in FIG. 14), and the storage unit stores a program or instructions. When the transceiver unit 1401 and the processing unit 1402 execute the program or the instructions, the first electronic device 1400 shown in FIG. 14 is enabled to perform the unlocking method described in the method embodiment.

For technical effects of the first electronic device 1400 shown in FIG. 14, refer to the technical effects of the unlocking method in the method embodiment. Details are not described herein again.

In addition to being in a form of the first electronic device 1400, the technical solution provided in this application may also be a functional unit or a chip in the first electronic device, or an apparatus used for matching the first electronic device.

In a possible design, FIG. 15 is a schematic diagram of a structure of a second electronic device according to an embodiment of this application. As shown in FIG. 15, the second electronic device 1500 may include a display unit 1501, a transceiver unit 1502, and a processing unit 1503. The second electronic device 1500 may be configured to implement a function of the second electronic device in the method embodiment.

Optionally, the display unit 1501 is configured to: support the second electronic device 1500 in displaying interface content, support the second electronic device 1500 in performing S1105 in FIG. 11A-1, and/or support the second electronic device 1500 in performing S1301 in FIG. 13B.

Optionally, the transceiver unit 1502 is configured to support the second electronic device 1500 in performing S1103, S1104, S1106, S1108a, and S1110 in FIG. 11A-1 and FIG. 11A-2, support the second electronic device 1500 in performing S1108b in FIG. 11B-2, and/or support the second electronic device 1500 in performing S1302 in FIG. 13B.

Optionally, the processing unit 1503 is configured to: support the second electronic device 1500 in performing S1105 and S1109 in FIG. 11A-1 and FIG. 11A-2, support the second electronic device 1500 in performing S1201 in FIG. 12B, and/or support the second electronic device 1500 in performing S1301 in FIG. 13B.

The transceiver unit may include a receiving unit and a sending unit, may be implemented by a transceiver or a transceiver-related circuit component, and may be the transceiver or a transceiver module. An operation and/or a function of each unit in the second electronic device 1500 is used to implement a corresponding procedure of the unlocking method in the method embodiment. All related content of each step in the method embodiment may be referenced to function descriptions of a corresponding functional unit. For brevity, details are not described herein again.

Optionally, the second electronic device 1500 shown in FIG. 15 may further include a storage unit (not shown in FIG. 15), and the storage unit stores a program or instructions. When the display unit 1501, the transceiver unit 1502, and the processing unit 1503 execute the program or the instructions, the second electronic device 1500 shown in FIG. 15 is enabled to perform the unlocking method described in the method embodiment.

For technical effects of the second electronic device 1500 shown in FIG. 15, refer to the technical effects of the unlocking method in the method embodiment. Details are not described herein again.

In addition to being in a form of the second electronic device 1500, the technical solution provided in this application may also be a functional unit or a chip in the second electronic device, or an apparatus used for matching the second electronic device.

An embodiment of this application further provides a chip system, including a processor. The processor is coupled to a memory. The memory is configured to store a program or instructions. When the program or the instructions is/are executed by the processor, the chip system is enabled to implement the method according to any one of the foregoing method embodiments.

Optionally, there may be one or more processors in the chip system. The processor may be implemented by hardware, or may be implemented by software. When the processor is implemented by the hardware, the processor may be a logic circuit, an integrated circuit, or the like. When the processor is implemented by the software, the processor may be a general-purpose processor, and is implemented by reading software code stored in the memory.

Optionally, there may also be one or more memories in the chip system. The memory may be integrated with the processor, or may be disposed separately from the processor. This is not limited in embodiments of this application. For example, the memory may be a non-transitory processor, for example, a read-only memory ROM. The memory and the processor may be integrated into a same chip, or may be separately disposed on different chips. A type of the memory and a manner of disposing the memory and the processor are not specifically limited in embodiments of this application.

For example, the chip system may be a field programmable gate array (field programmable gate array, FPGA), an application-specific integrated circuit (application-specific integrated circuit, ASIC), a system on a chip (system on a chip, SoC), a central processing unit (central processing unit, CPU), a network processor (network processor, NP), a digital signal processor (digital signal processor, DSP), a micro controller unit (micro controller unit, MCU), a programmable logic device (programmable logic device, PLD), or another integrated chip.

It should be understood that the steps in the foregoing method embodiment may be completed by using a hardware integrated logic circuit or instructions in a form of software in the processor. The steps of the method disclosed with reference to embodiments of this application may be directly performed by a hardware processor, or may be performed by a combination of hardware in the processor and a software module.

An embodiment of this application further provides a computer-readable storage medium. The computer-readable storage medium stores a computer program. When the computer program is run on a computer, the computer is enabled to perform the related steps, to implement the unlocking method in the embodiment.

An embodiment of this application further provides a computer program product. When the computer program product runs on a computer, the computer is enabled to perform the related steps, to implement the unlocking method in the embodiment.

In addition, an embodiment of this application further provides an apparatus. The apparatus may be a component or a module, and the apparatus may include one or more processors and memories that are connected. The memory is configured to store a computer program. When the computer program is executed by the one or more processors, the apparatus is enabled to perform the unlocking method in the method embodiment.

The apparatus, the computer-readable storage medium, the computer program product, or the chip provided in embodiments of this application are all configured to perform the corresponding method provided above. Therefore, for beneficial effects that can be achieved, refer to beneficial effects in the corresponding method provided above. Details are not described herein again.

Methods or algorithm steps described in combination with the content disclosed in embodiments of this application may be implemented by hardware, or may be implemented by a processor by executing a software instruction. The software instruction may include a corresponding software module. The software module may be stored in a random access memory (random access memory, RAM), a flash memory, a read-only memory (read only memory, ROM), an erasable programmable read only memory (erasable programmable ROM, EPROM), an electrically erasable programmable read only memory (electrically EPROM, EEPROM), a register, a hard disk drive, a removable hard disk, a compact disc read-only memory (CD-ROM), or any other form of storage medium well-known in the art. For example, a storage medium is coupled to a processor, so that the processor can read information from the storage medium or write information into the storage medium. Certainly, the storage medium may be a component of the processor. The processor and the storage medium may be located in an application-specific integrated circuit (application-specific integrated circuit, ASIC).

The foregoing descriptions about implementations allow a person skilled in the art to understand that, for the purpose of convenient and brief description, division into the foregoing functional modules is used as an example for illustration. In an actual application, the foregoing functions may be allocated to different functional modules and implemented based on a requirement, that is, an inner structure of an apparatus is divided into different functional modules to implement all or some of the functions described above. For a detailed working process of the foregoing system, apparatus, and units, refer to a corresponding process in the foregoing method embodiments. Details are not described herein again.

In the several embodiments provided in this application, it should be understood that the disclosed methods may be implemented in other manners. The apparatus embodiments described above are merely used as examples. For example, the module or unit division is merely logical function division, and there may be another division manner during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the modules or units may be implemented in an electronic form, a mechanical form, or another form.

In addition, functional units in embodiments of this application may be integrated into one processing unit, or each of the units may exist alone physically, or two or more units are integrated into one unit. The integrated unit may be implemented in a form of hardware, or may be implemented in a form of a software functional unit.

The computer-readable storage medium includes but is not limited to any one of the following media that can store program code: a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. An unlocking method, comprising:
determining, by a first electronic device, that there is a first risk in an environment in which the first electronic device is located;
establishing, by the first electronic device when determining that there is the first risk, a connection with a second electronic device, wherein the second electronic device is not allowed to establish a connection with the first electronic device when there is no first risk in the environment in which the first electronic device is located;
after the first electronic device establishes the connection to the second electronic device, sending, by the second electronic device, login account information of the second electronic device to a first server, wherein the first server is a server for managing a login account corresponding to the login account information;
receiving, by the second electronic device, a fourth signal sent by the first server, wherein the fourth signal is a signal sent by the first server after the first server determines unlocking authorization based on the login account information;
obtaining, by the second electronic device based on the fourth signal, unlocking authorization that allows controlling the first electronic device to perform unlocking;
sending, by the second electronic device, a first signal to the first electronic device, wherein the first signal indicates that the login account of the second electronic device is authorized; and
confirming, by the first electronic device based on the first signal, to perform unlocking.

2. The method according to claim 1, wherein before the sending, by the second electronic device, a first signal to the first electronic device, the method further comprises:
obtaining, by the second electronic device, a face image of a user who indicates, by using the second electronic device, to perform unlocking; and
sending, by the second electronic device, the face image of the user to a second server and/or the first electronic device, wherein the second server is a server for managing the first electronic device.

3. The method according to claim 1, wherein the determining, by the first electronic device, that there is the first risk in the environment in which the first electronic device is located comprises:
determining, by the first electronic device based on first data, that there is the first risk in the environment in which the first electronic device is located, wherein the first data comprises one or more of environment monitoring data, user monitoring data, user data, or security level data.

4. The method according to claim 3, the method further comprising:
obtaining, by the first electronic device, second data, wherein the second data comprises the first data;
determining, by the first electronic device based on the second data, whether there is the first risk in the environment in which the first electronic device is located; and
after the first electronic device determines that there is no first risk in the environment in which the first electronic device is located, confirming to perform locking.

5. An unlocking method, applied to a first electronic device, the method comprising:
obtaining first data;
determining, based on the first data, that there is a first risk in an environment in which the first electronic device is located;
establishing a connection to a second electronic device in response to a connection request sent by the second electronic device;
determining that a login account of the second electronic device is authorized; and
when there is the first risk in the environment in which the first electronic device is located, and it is determined that the login account of the second electronic device is authorized, confirming to perform unlocking.

6. The method according to claim 5, wherein the first data comprises one or more of environment monitoring data, user monitoring data, user data, or security level data.

7. The method according to claim 5, wherein the obtaining the first data comprises:
obtaining the first data sent by one or more of a sensor in the environment in which the first electronic device is located, a sensor of the first electronic device, a third electronic device that is provided with a sensor and that is in the environment in which the first electronic device is located, and a central control device in the environment in which the first electronic device is located.

8. The method according to claim 5, wherein the determining that the login account of the second electronic device is authorized comprises:
obtaining a first signal sent by the second electronic device, wherein the first signal carries authorization confirmation information sent by a first server to the second electronic device after the first server determines that the login account of the second electronic device is authorized; and
determining, based on the first signal, that the login account of the second electronic device is authorized.

9. The method according to claim 5, the method further comprising:
sending, by the first electronic device to the second electronic device, an identifier of the first electronic device and server information of a server associated with the first electronic device;
wherein the determining that the login account of the second electronic device is authorized comprises:
receiving, by the first electronic device from the server, a second signal including the identifier of the first electronic device and an identifier of the second electronic device; and
determining, based on the second signal, that the login account of the second electronic device is authorized.

10. The method according to claim 5, wherein before the confirming to perform unlocking, the method further comprises:
receiving a third signal sent by the second electronic device, wherein the third signal indicates the first electronic device to perform unlocking.

11. The method according to claim 5, wherein the login account of the second electronic device is authorized by a server associated with the first electronic device based on a face image of a user using the second electronic device or a login account provided by the second electronic device.

12. The method according to claim 5, wherein the first risk comprises one or more of the following: a fire risk, a flood risk, an individual activity risk of a child, or a risk of disease in the elderly.

13. The method according to claim 5, wherein after the determining, based on the first data, that there is the first risk in the environment in which the first electronic device is located, the method further comprises:
playing, by an audio module, an alarm audio, and/or
flashing an indicator light.

14. The method according to claim 5, the method further comprising:
obtaining second data that comprises the first data;
determining, based on the second data, whether there is the first risk in the environment in which the first electronic device is located; and
after it is determined that there is no first risk in the environment in which the first electronic device is located, confirming to perform locking.

15. An unlocking method, applied to a second electronic device, wherein the method comprises:
sending a connection request to a first electronic device, to establish a connection to the first electronic device;
displaying a first interface;
obtaining login account information in response to a first operation performed on the first interface;
obtaining, based on the login account information, unlocking authorization that allows controlling the first electronic device to perform unlocking; and
sending a first signal to the first electronic device, wherein the first signal indicates that a login account of the second electronic device is authorized.

16. The method according to claim 15, wherein the obtaining, based on the login account information, the unlocking authorization that allows controlling the first electronic device to perform unlocking comprises:
sending the login account information to a first server for unlocking authorization;
receiving a fourth signal sent by the first server in response to the login account information, wherein the fourth signal indicates the unlocking authorization; and
obtaining, based on the fourth signal, unlocking authorization that allows controlling the first electronic device to perform unlocking.

17. The method according to claim 16, the method further comprising:
receiving, from the first electronic device, a first identifier of the first electronic device and server information of a second server associated with the first electronic device; and
sending, to the first server, the first identifier of the first electronic device, a second identifier of the second electronic device and the server information of the second server to indicate the first server to send unlocking authorization result to the second server.

18. The method according to claim 15, wherein before the sending the first signal to the first electronic device, the method further comprises:
collecting a face image of a user; and
sending the face image of the user to a second server and/or the first electronic device, wherein the second server is a server for managing the first electronic device.

19. The method according to claim 15, wherein the sending a third signal to the first electronic device comprises:
displaying a second interface, and
sending a third signal to the first electronic device in response to a second operation performed on the second interface, wherein the third signal indicates the first electronic device to perform unlocking.

20. An electronic device, comprising:
a processor; and
a memory storing computer-readable instructions that, when executed by the processor, cause the electronic device to:
obtain first data;
determine, based on the first data, that there is a first risk in an environment in which the electronic device is located;
establish a connection to a second electronic device in response to a connection request sent by the second electronic device;
determine that a login account of the second electronic device is authorized; and
when there is the first risk in the environment in which the electronic device is located, and it is determined that the login account of the second electronic device is authorized, confirm to perform unlocking.
